(19) United States
(12) Patent Application Publication
(10) Pub. No.: US 2015/0272181 A1
(43) Pub. Date: Oct. 1, 2015

(54) REDUCED CALORIE VEGETABLE-BASED OR FRUIT-BASED FOOD PRODUCT AND/OR REDUCED CALORIE VEGETABLE-BASED OR FRUIT-BASED FOOD PRODUCT INGREDIENT AND PROCESS AND/OR METHOD FOR PREPARING OR MAKING SAME

(71) Applicants: MARY ANTONETTE SPANO a/k/a CALVI, YONKERS, NY (US); RAYMOND ANTHONY JOAO, YONKERS, NY (US)

(72) Inventors: MARY ANTONETTE SPANO a/k/a CALVI, YONKERS, NY (US); RAYMOND ANTHONY JOAO, YONKERS, NY (US)

(21) Appl. No.: 14/640,470

(22) Filed: Mar. 6, 2015

Related U.S. Application Data
(60) Provisional application No. 61/981,524, filed on Apr. 18, 2014.
(60) Provisional application No. 61/972,729, filed on Mar. 31, 2014.

(51) Int. Cl. A23L 1/212; A23L 1/01

(52) U.S. Cl. CPC A23L 1/2128; A23L 1/2121; A23L 1/0121; A23V 2002/00

(57) ABSTRACT

A reduced calorie food product or a reduced calorie food product ingredient made or prepared by a process, including simultaneously boiling, steaming, or boiling and steaming, a white vegetable or a fruit in, with, or using, a cooking liquid in or using a cooking pot or cooking utensil, food processing or blending the white vegetable or the fruit with at least a portion of the cooking liquid to form a vegetable base for the reduced calorie food product or for the reduced calorie food ingredient or to form a fruit base for the reduced calorie food product or for the reduced calorie food ingredient, and combining, adding, mixing, food processing, blending, or using, the vegetable base or the fruit base with at least one additional ingredient to finalize a preparation of the reduced calorie food product or the reduced calorie food product ingredient.

### RELATED APPLICATIONS

This application claims the benefit of the priority of U.S. Provisional Patent Application Ser. No. 61/981,524, filed Apr. 18, 2014, and entitled “REDUCED CALORIE VEGETABLE-BASED OR FRUIT-BASED FOOD PRODUCT AND/OR REDUCED CALORIE VEGETABLE-BASED OR FRUIT-BASED FOOD PRODUCT INGREDIENT AND PROCESS AND/OR METHOD FOR PREPARING OR MAKING SAME”, the subject matter and teachings of which are hereby incorporated by reference herein in their entirety. This application also claims the benefit of the priority of U.S. Provisional Patent Application Ser. No. 61/972,729, filed Mar. 31, 2014, and entitled “REDUCED CALORIE VEGETABLE-BASED OR FRUIT-BASED FOOD PRODUCT AND/OR REDUCED CALORIE VEGETABLE-BASED OR FRUIT-BASED FOOD PRODUCT INGREDIENT AND PROCESS AND/OR METHOD FOR PREPARING OR MAKING SAME”, the subject matter and teachings of which are hereby incorporated by reference herein in their entirety.

### FIELD OF THE INVENTION

The present invention pertains to a reduced calorie vegetable-based or fruit-based food product and/or a reduced calorie vegetable-based or fruit-based food product ingredient and process and/or method for preparing or making same and, in particular, to a reduced calorie vegetable-based or fruit-based food product and/or a reduced calorie vegetable-based or fruit-based food product ingredient and process and/or method for preparing or making same which can be, or which can be utilized in making, food products having a reduced fat content and/or having reduced calories compared to their conventional and/or traditional counterparts.

### BACKGROUND OF THE INVENTION

It is clear today, more than ever before, that there is a great need for foods, food products, and/or ingredients for food products, which are high and/or rich in nutrients and low in fat and/or low in calories. There is also a great need for foods, food products, and/or ingredients for food products, which are low in fat as well as being gluten-free and/or lactose-free. There is also no doubt that there is a need for foods which are healthy and taste great.

It is well known that many great tasting foods are made or prepared with or using ingredients which are high in fat and high in calories. These ingredients include, but certainly are not limited to, milks, whole milks, heavy creams, oils, butters, starches, and/or any other fat-rich and calorie-rich ingredients. While low-fat or low-calorie foods do exist in the marketplace or are readily available, they simply do not seem to have the richness and taste of many foods and food products which are made or prepared with ingredients which are high in fat and/or high in calories.

While low-fat and low-calorie foods can be found in the marketplace, they typically do not have the rich taste and/or rich texture of their higher in fat and/or higher in calorie counterparts. As a result, there is a need for low-fat and/or low-calorie foods, food products, or ingredients for food products, which are high in nutrients, low in fat, and/or low in calories, and which also have the taste and texture of some of the rich and great tasting foods which we have come to enjoy.

### SUMMARY OF THE INVENTION

The present invention pertains to a reduced calorie vegetable-based or fruit-based food product and/or a reduced calorie vegetable-based or fruit-based food product ingredient and process and/or method for preparing or making same and, in particular, to a reduced calorie vegetable-based or fruit-based food product and/or a reduced calorie vegetable-based or fruit-based food product ingredient and process and/or method for preparing or making same which can be, or which can be utilized in making, food products having a reduced fat content and/or having reduced calories compared to their conventional and/or traditional counterparts, which overcomes the shortfalls of the prior art.

The process and/or method of the present invention can be used to make any or prepare any vegetable-based food product, or any vegetable-based ingredient for a food product, or a fruit-based food product, or any fruit-based ingredient for food products which has reduced fat content and reduced calories than conventional or traditional food products counterparts. The food products and/or food product ingredients of the present invention can be made prepared without, or with minimal use of, milk(s), heavy cream(s), butter(s), dairy products, oil(s), starches, processed sugars, salt(s), or any other ingredients which typically introduce or add fat, sugars, salts, and/or calories into foods, thereby yielding reduced calorie food products and/or ingredients for food products which can, depending upon the food product or the ingredient for the food product, be low-fat, gluten-free, lactose free, or sugar-free, and have minimal or limited calories.

The vegetable base or fruit base of the present invention, or any combination of same, can also be made or prepared using the process and method of the present invention, with the resulting vegetable base or fruit base serving as a reduced calorie substitute for high fat or high calorie food ingredients and such as, or containing milk, heavy cream, butter, dairy products, oils, starches, processed sugars, salts, or any other foods or food ingredients which typically add fat, gluten, lactose, sugar, and/or salt, into a food products.

The process and/or method of the present invention can also be utilized, for example, to make or prepare a vegetable base which can be prepared by simultaneously boiling and steaming, or “beaming”, one or more white vegetables, such as, but not limited to, one or more of the herein-identified white vegetables, in and using a cooking liquid which, depending upon the food product to be prepared, can be, or can include, water, broth, juice, flavored water, or any combination of same. The simultaneous boiling and steaming, or “beaming” process can be performed or carried out in any suitable cooking pot, vessel, or container. The simultaneously boiling and steaming, or “beaming” process is carried out in a covered cooking pot, pan, vessel, or container.

The simultaneous boiling and steaming, or “beaming”, cooking operation serves to cook the white vegetable(s) a desired amount and serves to retain as much of the nutrients, which are typically extracting in a cooking process, as possible, with these nutrients being retained either in the white vegetable(s) and/or in the cooking liquid. Once the boiling and steaming process has been completed, the cooked white vegetable(s) and, either all or a portion of the cooking liquid in or with which they were boiled and steamed, can be food processed, or blended together, into and so as to form a smooth and/or creamy vegetable base. Any resulting vegetable base can be utilized, depending upon the food product to be made or prepared, as, or an ingredient to or for, a soup, a broth, a thickened broth, a bisque, a sauce, a gravy, a thickener, a chowder, a stew, a pot pie, a pot pie filling, a quiche, a custard, a filling, a food filling of any type or kind, a pasta filling, a meat filling, a vegetable filling, a vegetable spread, a stuffing, a crepe, a crepe filling, a dessert, a dessert filling, a pie filling, a cake filling, an icing, jellies, jams, preserves, marmalades, syrups, a bread, a bread filling, a drink, a beverage, a shake, a smoothie, or a frozen dessert, or any other food, food product, food ingredient, or food product ingredient.

Any type or kind of white vegetable can be used for making a vegetable base using the process and/or method of the present invention. The white vegetable can be placed in a cooking pot along with any other white vegetable, if used, or any other type or kind of vegetable, if used. A cooking liquid can then be added to the cooking pot so as to only partially submerge the white vegetable. The cooking liquid can be water, broth, juice, or any other flavored liquid, or any combination of same, in any desired mixture.

The simultaneous boiling and steaming, or “beaming”, of the white vegetable and any other contents of the cooking pot, if used, can then be performed until the desired texture and/or amount of cooking is achieved. Once the simultaneous boiling and steaming, or “beaming”, white vegetable and other contents, if used, is completed to the desired degree of cooking, the cooking process can cease.

The white vegetable and other contents, if used, can then be food processed along with all, or with any portion of the cooking liquid, so as to obtain a vegetable base having the desired base texture. Since vital nutrients can be retained in the cooking liquid, all of the cooking liquid can be used. If a thicker texture is desired of the vegetable base, then some cooking liquid can be removed. If the vegetable base obtained from the food processing step is all that is required at the time, then the process and method of the present invention can be complete. If the vegetable base is to be utilized as an ingredient for a food product, then it can then be utilized to prepare or make the food product.

Any type or kind of fruit can be used for making a fruit base using the process and/or method of the present invention. The fruit can be placed in a cooking pot along with any other fruits, if used, or any other type or kind of fruits, if used. A cooking liquid can then be added to the cooking pot so as to only partially submerge some or all of the fruit. The cooking liquid can be water, juice, or any other flavored liquid, or any combination of same, in any desired mixture.

The simultaneous boiling and steaming, or “beaming”, of the fruit and other contents of the cooking pot, if used, can then be performed until the desired texture and/or amount of cooking is achieved. Once the simultaneous boiling and steaming, or “beaming”, of the fruit and any other contents, if used, is completed to the desired degree of cooking, the cooking process can cease.

The fruit and other contents, if used, can then be food processed along with all, or with any portion of the cooking liquid, so as to obtain a fruit base having the desired base texture. Since vital nutrients can be retained in the cooking liquid, all of the cooking liquid can be used. If a thicker texture is desired of the fruit base, then some cooking liquid can be removed. If the fruit base obtained from the food processing step is all that is required at the time, then the process and method of the present invention can be complete. If the fruit base is to be utilized as an ingredient for a food product, then it can then be utilized to prepare or make the food product.

The reduced calorie vegetable-based or fruit-based food products and/or a reduced calorie vegetable-based or fruit-based food product ingredients of the present invention can be utilized in any desired way in order to make or prepare any desired food products, including, but not limited to, soups, broths, thickened broths, bisques, sauces, gravies, thickeners, chowders, stews, pot pies, pot pie fillings, quiches, custards, fillings, food fillings of any type or kind, pasta fillings, meat fillings, vegetable fillings, vegetable spreads, fruit spreads, stuffings, crepes, crepe fillings, desserts, dessert fillings, pie fillings, icings, cake fillings, jellies, jams, preserves, marmalades, syrups, syrups, breads, bread fillings, drinks, beverages, shakes, smoothies, and/or frozen desserts, and/or any other foods, food products, food ingredients, or food product ingredients.

The process and/or method of the present invention can be easily used in order to make or prepare a wide variety of reduced calorie vegetable-based food products or fruit-based food products and/or a reduced calorie vegetable-based, or fruit-based, food product ingredients, as well as wide variety of food dishes or food products which can be made or prepared with, from, or using, same.

The reduced calorie vegetable-based or fruit-based food products and/or a reduced calorie vegetable-based or fruit-based food product ingredients of the present invention can have a smooth and/or thick texture and/or can also have a uniformly smooth consistency and/or texture. The reduced calorie vegetable-based or fruit-based food products and/or a reduced calorie vegetable-based or fruit-based food product ingredients of the present invention can also be made or prepared commercially and/or in commercial manufacturing facilities and/or can be prepared by any individual.

The reduced calorie vegetable-based or fruit-based food products and/or a reduced calorie vegetable-based or fruit-based food product ingredients of the present invention can be made or prepared without heavy creams, butters, oils, fats, sugars, or starches, and/or can be made or prepared to be gluten-free or lactose-free, in order to satisfy any dietary needs of any individual.

Any “beamed” vegetable or fruit can be utilized as a low fat substitute for a pie crust, a quiche crust, a cooking bed or a baking bed, or can be used as a food or dish dressing or can be used for a food presentation purposes. In such an embodiment, any food processing step after “beaming” can be dispensed with, and the “beamed” vegetable or fruit can be removed from the cooking liquid and can be cut or sliced in any appropriate manner so as to be utilized as a low-fat vegetable or fruit substitute for a pie crust, a quiche crust, a cooking bed or a baking bed, or can be used as a food or dish dressing or can be used for a food presentation purposes.

The process and/or method of the present invention can also be utilized to make or prepare a vegetable base or a fruit base, and/or a vegetable-based food product or a fruit-based food product, which can be prepared by boiling one or more white vegetables or one or more fruits, in and using a cooking liquid which, depending upon the food product to be prepared, can be, or can include, water, broth, juice, flavored water, or any combination of same. The boiling process can be performed or carried out in any suitable cooking pot, vessel, or container.

The boiling operation serves to cook the white vegetable(s) or the fruit(s) a desired amount with as much of the nutrients as possible from the boiling process or operation being retained in either the white vegetable(s) or the fruit(s) and/or in the cooking liquid. Once the boiling process has been completed, the cooked white vegetable(s) or the fruit(s) and, either all or a portion of the cooking liquid in or with which they were boiled, can be food processed, or blended together, into and so as to form a respective smooth and/or creamy vegetable base or fruit base. The resulting vegetable base or fruit base can be utilized, depending upon the food product to be made or prepared, as, or as an ingredient to or for, a soup, a broth, a thickened broth, a bisque, a sauce, a gravy, a thickener, a chowder, a stew, a pot pie, a pot pie filling, a quiche, a custard, a filling, a food filling of any type or kind, a pasta filling, a meat filling, a vegetable filling, a vegetable spread, a stuffing, a crepe, a crepe filling, a dessert, a dessert filling, a pie filling, a cake filling, an icing, jellies, jams, preserves, marmalades, syrups, a bread, a bread filling, a drink, a beverage, a shake, a smoothie, or a frozen dessert, or any other food, food product, food ingredient, or food product ingredient.

The process and/or method of the present invention can also be utilized, for example, to make or prepare a vegetable base or a fruit base, and/or a vegetable-based food product or a fruit-based food product, which can be prepared by steaming one or more white vegetables or one or more fruits, in, with, and/or using, a cooking liquid which, depending upon the food product to be prepared, can be, or can include, water, broth, juice, flavored water, or any combination of same. The steaming process can be performed or carried out in any suitable cooking pot, vessel, or container.

The steaming operation serves to cook the white vegetable(s) or the fruit(s) a desired amount with as much of the nutrients as possible from the steaming process or operation being retained in either the white vegetable(s) or the fruit(s) and/or in the cooking liquid. Once the steaming process has been completed, the cooked white vegetable(s) or the fruit(s) and, either all or a portion of the cooking liquid in or with which they were steaming, can be food processed, or blended together, into and so as to form a respective smooth and/or creamy vegetable base or fruit base. The resulting vegetable base or fruit base can be utilized, depending upon the food product to be made or prepared, as, or an ingredient to or for, a soup, a broth, a thickened broth, a bisque, a sauce, a gravy, a thickener, a chowder, a stew, a pot pie, a pot pie filling, a quiche, a custard, a filling, a food filling of any type or kind, a pasta filling, a meat filling, a vegetable filling, a vegetable spread, a stuffing, a crepe, a crepe filling, a dessert, a dessert filling, a pie filling, a cake filling, an icing, jellies, jams, preserves, marmalades, syrups, a bread, a bread filling, a drink, a beverage, a shake, a smoothie, or a frozen dessert, or any other food, food product, food ingredient, or food product ingredient.

Any appropriate and/or suitable preservative(s), chemical preservative(s), or additive(s), can be added to any of the herein-described vegetable bases, fruit bases, vegetable-based food products, fruit-based food products, of the present invention or made or prepared using the process, processes, method, or methods, of the present invention, at any appropriate and/or suitable time so as to preserve same and/or to facilitate storing or packaging same for later consumption or use.

Any of the herein-described vegetable bases, fruit bases, vegetable-based food products, fruit-based food products, of the present invention or made or prepared using the process, processes, method, or methods, of the present invention can also be processed so as to be dehydrated or otherwise converted into a powdered form and, if desired, packaged, so as to preserve same and/or to facilitate storing or packaging same for later consumption or use, by using any appropriate and/or suitable processing, dehydrating, or other drying or conversion, or packaging, technique(s) and/or method(s).

Any of the herein-described vegetable bases, fruit bases, vegetable-based food products, fruit-based food products, of the present invention or made or prepared using the process, processes, method, or methods, of the present invention can also be processed so as to be frozen and, if desired, packaged by using any appropriate and/or suitable processing, freezing, or packaging, technique(s) and/or method(s).

Any of the herein-described vegetable bases, fruit bases, vegetable-based food products, fruit-based food products, of the present invention or made or prepared using the process, processes, method, or methods, of the present invention can also be processed so as to be freeze-dried and, if desired, packaged, by using any appropriate and/or suitable processing, freezing-drying, or packaging, technique(s) and/or method(s).

Any of the herein-described vegetable bases, fruit bases, vegetable-based food products, fruit-based food products, of the present invention or made or prepared using the process, processes, method, or methods, of the present invention can also be frozen, packaged, jarred, canned, or bottled, by using any appropriate and/or suitable processing, reducing, concentrating, packaging, jarring, canning, or bottling, technique(s) and/or method(s).

Any of the herein-described vegetable bases, fruit bases, vegetable-based food products, fruit-based food products, of the present invention or made or prepared using the process, processes, method, or methods, of the present invention can also be packaged, jarred, canned, or bottled, by using any appropriate and/or suitable packaging, jarring, canning, or bottling, technique(s) and/or method(s).

Any of the vegetable bases, vegetable-based food products, fruit bases, or fruit-based food products, described herein can be prepared or produced in any quantities, can be prepared or produced for individual consumption, for family consumption, for mass consumption, and/or can be prepared or produced for commercial sale. Any of the vegetable bases, vegetable-based food products, fruit bases, or fruit-based food products, described herein also can be canned, jarred, bottled, dehydrated, dehydrated into a powdered form, frozen, freeze-dried, or prepared as a frozen concentrate, and/or can be packaged, jarred, canned, or bottled, for personal use or for commercial distribution, use, and/or sale.

Any of the vegetable bases or fruit bases of the present invention, or any food products or ingredients of or for food products, which can be made or prepared with or from same, can be further processed, in any appropriate and/or suitable manner, so as to be dried or dehydrated so as to convert same to a powdered form for later rehydration and use, or can be frozen for later use, or can be freeze-dried for later user. In this regard, the process and/or method of the present invention can also include a respective dehydration process, a freezing process, or a freeze-drying process and/or the vegetable bases or fruit bases of the present invention, or any food products or ingredients of or for food products, which can be made or prepared with or from same, can be dehydrated or powered vegetable bases or fruit bases of the present invention, or any food products or ingredients of or for food products, frozen vegetable bases or fruit bases of the present invention, or any food products or ingredients of or for food products, or freeze-dried vegetable bases or fruit bases of the present invention, or any food products or ingredients of or for food products.

Any type, kind, or variety of vegetables including, but not limited to, white vegetables, green vegetables, root vegetables, or any other vegetables or vegetable-like products, items, or entities, can be used to make or to prepare any vegetable base described herein or otherwise or any reduced calorie food product or a reduced calorie food product ingredient of the present invention.

Any type, kind, or variety of fruits including, but not limited to, white fruits, citrus fruits, berries, strawberries, blueberries, blackberries, raspberries, bananas, cherries, oranges, grapefruits, peaches, pears, plums, prunes, currants, or any other fruit or fruit-like products, items, or entities, can be used to make or to prepare a fruit base described herein or otherwise or any reduced calorie food product or a reduced calorie food product ingredient of the present invention.

The vegetable bases, the vegetable-based food products, or the fruit bases or the fruit-based food products, of the present invention, and/or prepared by and using the processes and methods of the present invention, can be used to prepare and/or make any number, kinds, or types, of a wide variety of food products or ingredients for food products. As and for an exemplary and non-exhaustive list, the vegetable bases, the vegetable-based food products, or the fruit bases, or the fruit-based food products, of the present invention can be prepared as, or can be an ingredient for, mashed potatoes, mashed cauliflower, mashed vegetables of any type or kind or of any combination, macaroni and cheese, hashed browns, au gratin potatoes, crab cakes, fish cakes, fish sticks, Shepherd's pie, dips of any type of kind, hummus, and/or any other food product or food product ingredient which can be prepared or made by using the process and method of the present invention, and/or any type of kind of soups, broths, thickened broths, bisques, sauces, gravies, thickeners, chowders, stews, pot pies, pot pie fillings, quiches, custards, fillings, food fillings of any type or kind, pasta fillings, meat fillings, vegetable fillings, vegetable spreads, stuffings, crepes, crepe fillings, desserts, dessert fillings, pie fillings, cake fillings, icings, jellies, jams, preserves, marmalades, syrups, breads, bread fillings, drinks, beverages, shakes, smoothies, or frozen desserts, or any other foods, food products, food ingredients, or food product ingredients.

Vegetables such as onions, cabbage, potatoes, or other like vegetables, can also be utilized in a cooking or baking process. For example, an onion or onions can be sliced and used as a vegetable baking bed which can serve a bed upon which a food product can be place during cooking or baking. For example, a meatloaf made with any combination of or type of meats can be placed on a bed of onions slices or onion pieces in order to provide a non-fat or low fat cooking or backing surface.

Any of the vegetable bases or fruit bases of the present invention, or any food products or ingredients of or for food products, which can be made or prepared with or from same, can be further processed, in any appropriate and/or suitable manner, so as to be dried or dehydrated so as to convert same to a powdered form for later rehydration and use, or can be frozen for later use, or can be freeze-dried for later user. In this regard, the process and/or method of the present invention can also include a respective dehydration process, a freezing process, or a freeze-drying process and/or the vegetable bases or fruit bases of the present invention, or any food products or ingredients of or for food products, which can be made or prepared with or from same, can be dehydrated or powered vegetable bases or fruit bases of the present invention, or any food products or ingredients of or for food products, frozen vegetable bases or fruit bases of the present invention, or any food products or ingredients of or for food products, or freeze-dried vegetable bases or fruit bases of the present invention, or any food products or ingredients of or for food products.

In any and/or all of the embodiments described herein any type, kind, or variety of vegetables including, but not limited to, white vegetables, green vegetables, root vegetables, or any other vegetables or vegetable-like products, items, or entities, can be used to make or to prepare any vegetable base described herein or otherwise or any reduced calorie food product or a reduced calorie food product ingredient of the present invention.

In any and/or all of the embodiments described herein any type, kind, or variety of fruits including, but not limited to, white fruits, citrus fruits, berries, strawberries, blueberries, blackberries, raspberries, bananas, cherries, oranges, grapefruits, peaches, pears, plums, prunes, currants, or any other fruit or fruit-like products, items, or entities, can be used to make or to prepare a fruit base described herein or otherwise or any reduced calorie food product or a reduced calorie food product ingredient of the present invention.

Any of the herein-described vegetable-based or fruit-based food products and/or reduced calorie vegetable-based or fruit-based food product ingredients, can also prepared, or made, with or including any suitable food, nutritional, or dietary, supplement, such as, but not limited to, a liquid vitamin or a liquid vitamin mixture, a liquid food supplement, a liquid nutritional supplement, a liquid dietary supplement, a liquid energy product, or any other liquid supplement or supplements.

Any of the herein-described vegetable-based or fruit-based food products and/or reduced calorie vegetable-based or fruit-based food product ingredients, can also prepared, or made, with or including any solid or powdered form of a vitamin or a vitamin mixture, a solid or powdered form of a food supplement, nutritional supplement, or dietary supplement, a solid or powdered energy product, or any other solid or powdered food, nutritional, or dietary, supplement or supplements.

### BRIEF DESCRIPTION OF THE DRAWINGS

In The Drawings:

FIG. 1 illustrates a preferred embodiment method for making or preparing a reduced calorie vegetable-based food product, and/or a reduced calorie vegetable-based food product ingredient, of the present invention, in flow diagram form;

FIG. 2 illustrates a preferred embodiment method for making or preparing a reduced calorie fruit-based food product, and/or a reduced calorie fruit-based food product ingredient, of the present invention, in flow diagram form;

FIG. 3 illustrates yet another preferred embodiment method for making or preparing a reduced calorie vegetable-based food product, and/or a reduced calorie vegetable-based food product ingredient, of the present invention, in flow diagram form;

FIG. 4 illustrates yet another preferred embodiment method for making or preparing a reduced calorie fruit-based food product, and/or a reduced calorie fruit-based food product ingredient, of the present invention, in flow diagram form;

FIG. 5 illustrates still another preferred embodiment method for making or preparing a reduced calorie vegetable-based food product, and/or a reduced calorie vegetable-based food product ingredient, of the present invention, in flow diagram form; and

FIG. 6 illustrates still another preferred embodiment method for making or preparing a reduced calorie fruit-based food product, and/or a reduced calorie fruit-based food product ingredient, of the present invention, in flow diagram form.

### DESCRIPTION OF THE PREFERRED EMBODIMENTS

The present invention pertains to a reduced calorie vegetable-based or fruit-based food product and/or a reduced calorie vegetable-based or fruit-based food product ingredient and process and/or method for preparing or making same and, in particular, to a reduced calorie vegetable-based or fruit-based food product and/or a reduced calorie vegetable-based or fruit-based food product ingredient and process and/or method for preparing or making same which can be, or which can be utilized in making, food products having a reduced fat content and/or having reduced calories compared to their conventional and/or traditional counterparts.

The reduced calorie vegetable-based or fruit-based food products of the present invention can be, can be used as an ingredient or as ingredients in, or can be utilized in making or preparing, soups, broths, thickened broths, bisques, sauces, gravies, thickeners, chowders, stews, pot pies, pot pie fillings, quiches, custards, fillings, food fillings of any type or kind, pasta fillings, meat fillings, vegetable fillings, vegetable spreads, fruit spreads, stuffings, crepes, crepe fillings, desserts, dessert fillings, pie fillings, icings, cake fillings, jellies, jams, preserves, marmalades, syrups, syrups, breads, bread fillings, drinks, beverages, shakes, smoothies, and/or frozen desserts, and/or any other foods, food products, food ingredients, or food product ingredients.

The reduced calorie vegetable-based or fruit-based food products of the present invention can be, can be used as an ingredient or as ingredients in, or can be utilized in making or preparing, hot dishes, cold dishes, or frozen dishes, of any kind, type, or variety.

As used herein, the term “beam” (and its correlative terms “beamed” and “beaming”) means and/or refers to a method or process of cooking or preparing a food product, a food ingredient, or a food product ingredient, or a vegetable, or more than one type or kind of vegetables, or a fruit, or more than one type or kind of fruits, which involves the simultaneous boiling and steaming of same in, with, using, or involving, a liquid.

As used herein, the term “base” means and/or refers to the resulting food product, food product ingredient, or ingredient of a food product, which is created or produced as the result of food processing or blending a beamed vegetable, beamed vegetables, a beamed fruit, or beamed fruits, or any combination or mixture of same, in and/or with at least a portion of the liquid used during the beaming process.

As used herein, the term “vegetable base” means or refers to a base made or prepared with, from, using, or containing, a vegetable or any number of types or kinds of vegetables.

As used herein, the term “fruit base” means or refers to a base made or prepared with, from, using, or containing, a fruit or any number of types or kinds of fruits.

As used herein, the term “white vegetable” means or refers to a cauliflower, garlic, onions, shallots, leeks, cabbage, broccoli, endive, or anise, or jicama, or any cruciferous vegetable, or any vegetable having a white, a neutral, a white-like, or a light, color, or any vegetable having a bland, a neutral, or a weak, taste or flavor.

As used herein, the term “white fruit” means or refers to an apple, pear, coconut, or banana, or any fruit having a white, a white-like, or a light, color, mesocarp, or flesh, or any fruit having a bland, a neutral, or a weak, flavor or flavoring.

Applicant hereby incorporates by reference herein the subject matter and teachings of U.S. Provisional Patent Application Ser. No. 61/981,524, filed Apr. 18, 2014, and entitled “REDUCED CALORIE VEGETABLE-BASED OR FRUIT-BASED FOOD PRODUCT AND/OR REDUCED CALORIE VEGETABLE-BASED OR FRUIT-BASED FOOD PRODUCT INGREDIENT AND PROCESS AND/OR METHOD FOR PREPARING OR MAKING SAME”, the subject matter and teachings of which are hereby incorporated by reference herein in their entirety. Applicant also hereby incorporates by reference herein the subject matter and teachings of U.S. Provisional Patent Application Ser. No. 61/972,729, filed Mar. 31, 2014, and entitled “REDUCED CALORIE VEGETABLE-BASED OR FRUIT-BASED FOOD PRODUCT AND/OR REDUCED CALORIE VEGETABLE-BASED OR FRUIT-BASED FOOD PRODUCT INGREDIENT AND PROCESS AND/OR METHOD FOR PREPARING OR MAKING SAME”, the subject matter and teachings of which are hereby incorporated by reference herein in their entirety.

In a preferred embodiment, the process and/or method of the present invention can be used to make any or prepare any vegetable-based food product, or any vegetable-based ingredient for a food product, or a fruit-based food product, or any fruit-based ingredient for food products which has reduced fat content and reduced calories than conventional or traditional food products counterparts. The food products and/or food product ingredients of the present invention can be made prepared without, or with minimal use of, milk(s), heavy cream(s), butter(s), dairy products, oil(s), starches, processed sugars, salt(s), or any other ingredients which typically introduce or add fat, sugars, salts, and/or calories into foods, thereby yielding reduced calorie food products and/or ingredients for food products which can, depending upon the food product or the ingredient for the food product, be low-fat, gluten-free, lactose free, or sugar-free, and have minimal or limited calories.

In a preferred embodiment to the present invention, a vegetable base or fruit base, or any combination of same, can also be made or prepared using the process and method of the present invention, with the resulting vegetable base or fruit base serving as a reduced calorie substitute for high fat or high calorie food ingredients and such as, or containing milk, heavy cream, butter, dairy products, oils, starches, processed sugars, salts, or any other foods or food ingredients which typically add fat, gluten, lactose, sugar, and/or salt, into a food products.

In a preferred embodiment, the process and/or method of the present invention can be utilized, for example, to make or prepare a vegetable base which can be prepared by simultaneously boiling and steaming, or “beaming”, one or more white vegetables, such as, but not limited to, one or more of the herein-identified white vegetables, in and using a cooking liquid which, depending upon the food product to be prepared, can be, or can include, water, broth, juice, flavored water, or any combination of same. The simultaneous boiling and steaming, or “beaming” process can be performed or carried out in any suitable cooking pot, vessel, or container. In a preferred embodiment, the simultaneously boiling and steaming, or “beaming” process is carried out in a covered cooking pot, pan, vessel, or container.

The simultaneous boiling and steaming, or “beaming”, cooking operation serves to cook the white vegetable(s) a desired amount and serves to retain as much of the nutrients, which are typically extracting in a cooking process, as possible, with these nutrients being retained either in the white vegetable(s) and/or in the cooking liquid. Once the boiling and steaming process has been completed, the cooked white vegetable(s) and, either all or a portion of the cooking liquid in or with which they were boiled and steamed, can be food processed, or blended together, into and so as to form a smooth and/or creamy vegetable base. In a preferred embodiment of the present invention, the resulting vegetable base can be utilized, depending upon the food product to be made or prepared, as, or an ingredient to or for, a soup, a broth, a thickened broth, a bisque, a sauce, a gravy, a thickener, a chowder, a stew, a pot pie, a pot pie filling, a quiche, a custard, a filling, a food filling of any type or kind, a pasta filling, a meat filling, a vegetable filling, a vegetable spread, a stuffing, a crepe, a crepe filling, a dessert, a dessert filling, a pie filling, a cake filling, an icing, jellies, jams, preserves, marmalades, syrups, a bread, a bread filling, a drink, a beverage, a shake, a smoothie, or a frozen dessert, or any other food, food product, food ingredient, or food product ingredient.

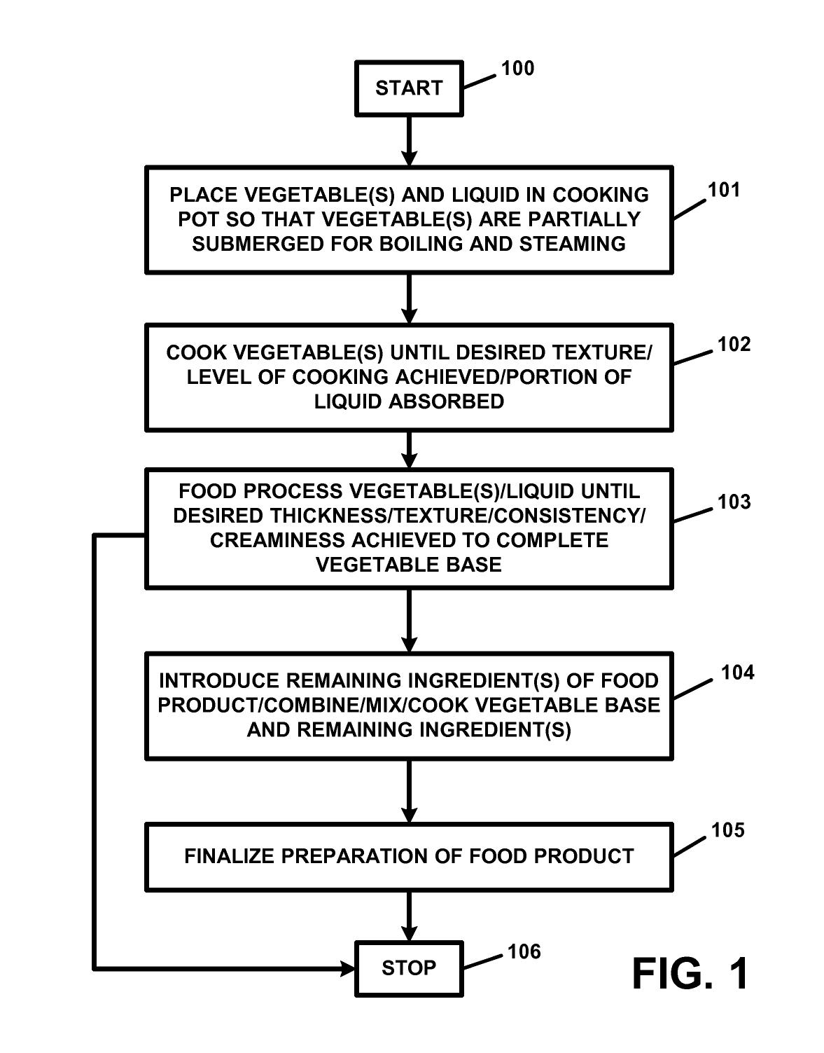

FIG. 1 illustrates a preferred embodiment method for making or preparing a reduced calorie vegetable-based product, and/or a reduced calorie vegetable-based food product ingredient, of the present invention, in flow diagram form. In the preferred embodiment of FIG. 1, the process and/or method of the present invention is described, in an exemplary embodiment, as being utilized to make or prepare clam chowder. It is, however, important to note that, although described as being utilized to make or prepare clam chowder, the process and/or method of the present invention can also be utilized in a same, a similar, and/or an analogous, manner in order to make or prepare any vegetable-based food product or vegetable-based ingredient for a food product which can be, or which can be used an ingredient for soups, broths, thickened broths, bisques, sauces, gravies, thickeners, chowders, stews, pot pies, pot pie fillings, quiches, custards, fillings, food fillings of any type or kind, pasta fillings, meat fillings, vegetable fillings, vegetable spreads, stuffings, crepes, crepe fillings, desserts, dessert fillings, pie fillings, cake fillings, icings, jellies, jams, preserves, marmalades, syrups, breads, bread fillings, drinks, beverages, shakes, smoothies, and/or frozen desserts, and/or any other foods, food products, food ingredients, or food product ingredients, each of which is a product of or a subject of the present invention.

With reference to FIG. 1, the process or method of the present invention commences at step 100. At step 101, a white vegetable, such as cauliflower, and/or any other white vegetable, or any other type or kind of vegetable for that matter, if desired, can be used for making the vegetable base for the clam chowder. At step 101, the cauliflower can be placed in the cooking pot along with any other white vegetable, if used, or any other type or kind of vegetable, if used. The cooking liquid can then be added to the pot so as to only partially submerge the cauliflower. In a preferred embodiment, the cooking liquid can be water, clam juice, or any other flavored liquid or juice, or any combination of same, in any desired mixture. In a preferred embodiment, the vegetable(s) can be placed on the bottom of the cooking pot and/or can be placed in a colander or steaming utensil within the cooking pot.

At step 101, if desired, any salt, pepper, or any other condiment or spice or spices, can also be added to the cooking pot. Thereafter, the cooking pot can be covered so as to contain and/or retain all steam during cooking.

At step 102, the cooking of the contents of the cooking pot can commence and the simultaneous boiling and steaming, or “beaming”, of the cauliflower can be performed until the desired texture and/or amount of cooking is achieved. Once the simultaneous boiling and steaming, or “beaming”, of the cauliflower is completed to the desired degree of cooking, the cooking process can cease.

At step 103, the cooking pot cover can be removed and the cauliflower and cooking liquid can be food processed or blended together either in the cooking pot or in a separate food processor or blender. In a preferred embodiment, the cauliflower can be food processed along with all, or with any portion of the cooking liquid, so as to obtain a vegetable base having the desired base texture. Since vital nutrients from the cauliflower can be retained in the cooking liquid, in a preferred embodiment, all of the cooking liquid can be used. In another embodiment, if a thicker texture is desired of the vegetable base, then some cooking liquid can be removed. In another preferred embodiment, any other ingredients can be added to the cauliflower and cooking liquid combination either before, during, or after, the food processing or blending step. If the vegetable base obtained from the food processing step is all that is required at the time, then the process and method of the present invention can be completed at the end of step 103 and the vegetable base can be used, consumed, or stored, as desired, and the process and/or method of the present invention will be completed at step 106.

At step 104, the remaining ingredients of the clam chowder, which can contain claims, clam juice, any other vegetables, meats, fish, cheeses, sauces, or any other spices or flavoring, or any other ingredients, of or for clam chowder, which, in a preferred embodiment, were prepared separately from the vegetable base, can be added to the vegetable base, and the vegetable base and the added remaining ingredients of the clam chowder can be mixed together and/or can be cooked together, for a desired amount of time, to complete the clam chowder. At step 104, any additional food processing or blending operation can also be performed, if desired. Any cooking or food processing performed at step 104 can be performed in the cooking pot, a food processor, or any other pot or container. At step 104, the contents of the cooking pot can also be further reduced so as to thicken same, if desired. Thereafter, at step 105, the preparation of the clam chowder can be completed and the process and/or method of the present invention will be completed at step 106.

In another preferred embodiment, any appropriate and/or suitable preservative(s), chemical preservative(s), or additive(s), can be added to the vegetable base(s) at or during step 103, or can be added to the vegetable-based food product(s) at or during step 104 or at or during 105, so as to preserve same and/or to facilitate storing or packaging same for later consumption or use.

In another preferred embodiment, the vegetable base(s) can also be processed so as to be dehydrated or otherwise converted into a powdered form and, if desired, packaged, at or during step 103, or the vegetable-based food product(s) can also be processed so as to be dehydrated or otherwise converted into a powdered form and, if desired, can also be packaged, at or during step 105, using any appropriate and/or suitable processing, dehydrating, or other drying or conversion, or packaging, technique(s) and/or method(s).

In another preferred embodiment, the vegetable base(s) can also be processed so as to be frozen and, if desired, packaged at or during step 103, or the vegetable-based food product(s) can also be frozen and, if desired, packaged, at or during step 105, using any appropriate and/or suitable processing, freezing, or packaging, technique(s) and/or method(s).

In another preferred embodiment, the vegetable base(s) can also be processed so as to be freeze-dried and, if desired, packaged at or during step 103, or the vegetable-based food product(s) can also be processed so as to be freeze-dried and, if desired, packaged, at or during step 105, using any appropriate and/or suitable processing, freezing-drying, or packaging, technique(s) and/or method(s).

In another preferred embodiment, the vegetable base(s) can also be processed so as to be reduced to a concentrated vegetable base product, and, if desired, can be frozen, packaged, jarred, canned, or bottled, at or during step 103, or the vegetable-based food product(s) can also be processed so as to be reduced to a concentrated vegetable base product, and, if desired, can be frozen, packaged, jarred, canned, or bottled, at or during step 105, using any appropriate and/or suitable processing, reducing, concentrating, packaging, jarring, canning, or bottling, technique(s) and/or method(s).

In another preferred embodiment, the vegetable base(s) can also be packaged, jarred, canned, or bottled, at or during step 103, or the vegetable-based food product(s) can also be packaged, jarred, canned, or bottled, at or during step 105, using any appropriate and/or suitable packaging, jarring, canning, or bottling, technique(s) and/or method(s).

In another preferred embodiment, the present invention can be any, or can be used to make or prepare any, fruit-based food product, or any fruit-based ingredient for a food product. In a preferred embodiment, the process and/or method of the present invention can be utilized, for example, to make or prepare a fruit base which can be prepared by simultaneously boiling and steaming, or “beaming”, one or more fruits in and using a cooking liquid which, depending upon the food product to be prepared, can be, or can include, water, broth, juice, flavored water, or any combination of same. The simultaneous boiling and steaming, or “beaming” process can be performed or carried out in any suitable cooking pot, pan, vessel, or container. In a preferred embodiment, the simultaneously boiling and steaming, or “beaming” process is carried out in a covered cooking pot, pan, vessel, or container.

The simultaneous boiling and steaming, or “beaming”, cooking operation serves to cook the fruit(s) a desired amount and serves to retain as much of the nutrients, which are typically extracted in and during a cooking process, as possible with these nutrients being retained either in the fruits(s) and/or in the cooking liquid. Once the boiling and steaming process has been completed, the cooked fruit(s) and, either all or a portion of the cooking liquid in or with which they were boiled and steamed, can be food processed, or blended together, into and so as to form a smooth and/or creamy fruit base. In a preferred embodiment of the present invention, the resulting fruit base can be utilized, depending upon the food product to be made or prepared, as, or an ingredient of or for, a thickener, a custard, a filling, a food filling of any type or kind, a pasta filling, a meat filling, a vegetable filling, a stuffing, a crepe, a crepe filling, a dessert, a dessert filling, a pie filling, a cake filling, an icing, a fruit spread, a jelly, a jam, preserves, a marmalade, syrup, a bread, a bread filling, a drink, a beverage, a shake, a smoothie, or a frozen dessert, or any other food, food product, food ingredient, or food product ingredient.

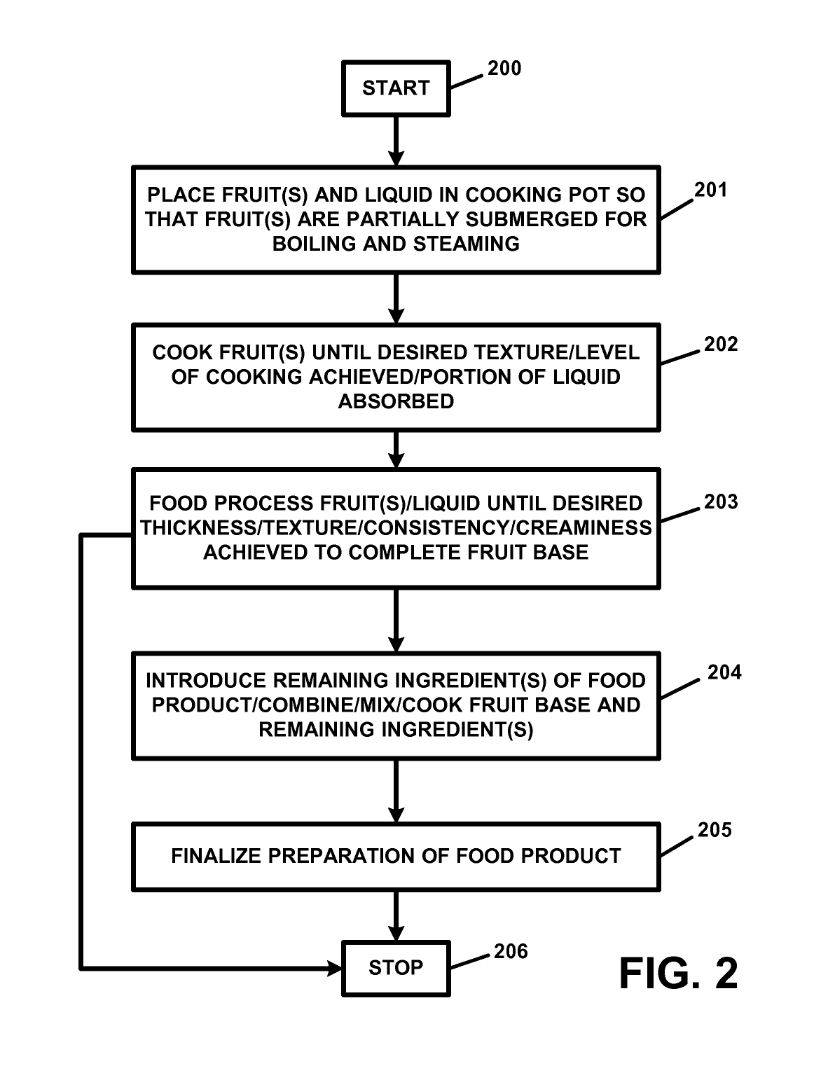

FIG. 2 illustrates a preferred embodiment method for making or preparing a reduced calorie fruit-based food product, and/or a reduced calorie fruit-based food product ingredient, of the present invention, in flow diagram form.

In a preferred embodiment, the present invention can be any, or can be used to make or prepare any, fruit-based food product, or any fruit-based ingredient for a food product. In a preferred embodiment, the process and/or method of the present invention can be utilized, for example, to make or prepare a fruit base which can be prepared by simultaneously boiling and steaming, or “beaming”, one or more fruits in and using a cooking liquid which, depending upon the food product to be prepared, can be, or can include, water, juice, flavored water, or any combination of same. The simultaneous boiling and steaming, or “beaming” process can be performed or carried out in any suitable cooking pot, pan, vessel, or container. In a preferred embodiment, the simultaneously boiling and steaming, or “beaming” process is carried out in a covered cooking pot, pan, vessel, or container.

The simultaneous boiling and steaming, or “beaming”, cooking operation serves to cook the fruit(s) a desired amount and serves to retain as much of the nutrients, which are typically extracted in and during a cooking process, as possible with these nutrients being retained either in the fruit(s) and/or in the cooking liquid. Once the boiling and steaming process has been completed, the cooked fruit(s) and, either all or a portion of the cooking liquid in or with which they were boiled and steamed, can be food processed, or blended together, into and so as to form a smooth and/or creamy fruit base. In a preferred embodiment of the present invention, the resulting fruit base can be utilized, depending upon the food product to be made or prepared, as, or an ingredient for a thickener, a custard, a filling, a food filling of any type or kind, a pasta filling, a meat filling, a vegetable filling, a stuffing, a crepe, a crepe filling, a dessert, a dessert filling, a pie filling, a cake filling, a jelly, a jam, preserves, a marmalade, syrup, a bread, a bread filling, a drink, a beverage, a shake, a smoothie, or a frozen dessert, or any other food, food product, food ingredient, or food product ingredient.

FIG. 2 illustrates a preferred embodiment method for making or preparing a reduced calorie fruit-based food product, and/or a reduced calorie fruit-based food product ingredient, of the present invention, in flow diagram form.

In the preferred embodiment of FIG. 2, the process and/or method of the present invention is described, in an exemplary embodiment, as being utilized to make or prepare a fruit based ingredient for crepes, filled or stuffed pasta, raviolis, or pierogies, or any other fruit-filled food products. It is, however, important to note that, although described as being utilized to make or prepare a fruit base for use in crepes, filled or stuffed pasta, raviolis, or pierogies, or any other fruit-filled food products, the process and/or method of the present invention can also be utilized in a same, a similar, and/or an analogous, manner in order to make or prepare any fruit-based food product or fruit-based ingredient for a food product which can be, or which can be used an ingredient for custards, fillings, food fillings of any type or kind, pasta fillings, meat fillings, vegetable fillings, fruit spreads, stuffings, crepes, crepe fillings, desserts, dessert fillings, pie fillings, cake fillings, icings, jellies, jams, preserves, marmalades, syrups, breads, bread fillings, drinks, beverages, shakes, smoothies, and/or frozen desserts, and/or any other foods, food products, food ingredients, or food product ingredients, each of which is a product of or a subject of the present invention.

With reference to FIG. 2, the process or method of the present invention commences at step 200. At step 201, a fruit or fruits, such as blueberries or strawberries, or any combination of fruits, if desired, can be used for making the fruit base for the crepes, filled or stuffed pasta, raviolis, or pierogies, or any other fruit-filled food products. In a preferred embodiment, blueberries can be utilized as the fruit with which the fruit-based food product or fruit-based fruit product ingredient can be made or prepared. At step 201, the blueberries can be placed in the cooking pot and/or in a colander or steaming utensil within the cooking pot. The cooking liquid can then be added to the cooking pot so as to only partially submerge some, but not all of, the blueberries. In a preferred embodiment, the cooking liquid can be water, blueberry juice, any other fruit juice, or any other flavored liquid or juice, or any combination of same, in any desired mixture. At step 201, if desired, any type or kind of sweetener or sugar can also be added to the cooking pot, if desired. Thereafter, the cooking pot can be covered so as to contain and/or retain all steam during cooking.

At step 202, the cooking of the contents of the cooking pot can commence and the simultaneous boiling and steaming, or “beaming”, of the blueberries can be performed until the desired texture and/or amount of cooking is achieved. Once the simultaneous boiling and steaming, or “beaming”, of the blueberries is completed to the desired degree of cooking, the cooking process can cease.

At step 203, the cooking pot cover can be removed and the blueberries and cooking liquid can be food processed or blended together either in the cooking pot or in a separate food processor or blender. In a preferred embodiment, the blueberries can be food processed along with all, or with any portion of the cooking liquid, so as to obtain a fruit base having the desired base texture. Since vital nutrients from the blueberries can be retained in the cooking liquid, in a preferred embodiment, all of the cooking liquid can be used. In another embodiment, if a thicker texture is desired of the fruit base, then some cooking liquid can be removed. In another preferred embodiment, any other ingredients can be added to the blueberries and cooking liquid combination either before, during, or after, the food processing or blending step. If the fruit base obtained from the food processing step is all that is required at the time, then the process and method of the present invention can be completed at the end of step 203 and the fruit base can be used, consumed, or stored, as desired, and the process and/or method of the present invention will be completed at step 206.

At step 204, any additional ingredients can be added to the fruit base, such as, for example, whole and/or cut fresh blueberries, or any ingredient(s), and the fruit base and the added ingredients can be mixed together and/or can be cooked together, if desired, for any desired amount of time in order to complete the fruit-base food product. At step 204, any additional food processing or blending operation can also be performed, if desired. Any cooking or food processing performed at step 204 can be performed in the cooking pot, a food processor, or any other pot or container. At step 204, the contents of the cooking pot can also be further reduced so as to thicken same, if desired. Thereafter, at step 205, the completed blueberry fruit-based food product can be used as a filling or stuffing to make or prepare blueberry filled crepes, filled or stuffed pasta, raviolis, or pierogies, or any other fruit-filled food products, and the process and/or method of the present invention will be completed at step 206.

In another preferred embodiment, any appropriate and/or suitable preservative(s), chemical preservative(s), or additive(s), can be added to the fruit base(s) at or during step 203, or can be added to the fruit-based food product(s) at or during step 204 or at or during 205, so as to preserve same and/or to facilitate storing or packaging same for later consumption or use.

In another preferred embodiment, the fruit base(s) can also be processed so as to be dehydrated or otherwise converted into a powdered form and, if desired, packaged, at or during step 203, or the fruit-based food product(s) can also be processed so as to be dehydrated or otherwise converted into a powdered form and, if desired, can also be packaged, at or during step 205, using any appropriate and/or suitable processing, dehydrating, or other drying or conversion, or packaging, technique(s) and/or method(s).

In another preferred embodiment, the fruit base(s) can also be processed so as to be frozen and, if desired, packaged at or during step 203, or the fruit-based food product(s) can also be frozen and, if desired, packaged, at or during step 205, using any appropriate and/or suitable processing, freezing, or packaging, technique(s) and/or method(s).

In another preferred embodiment, the fruit base(s) can also be processed so as to be freeze-dried and, if desired, packaged at or during step 203, or the fruit-based food product(s) can also be processed so as to be freeze-dried and, if desired, packaged, at or during step 205, using any appropriate and/or suitable processing, freezing-drying, or packaging, technique(s) and/or method(s).

In another preferred embodiment, the fruit base(s) can also be processed so as to be reduced to a concentrated vegetable base product, and, if desired, can be frozen, packaged, jarred, canned, or bottled, at or during step 203, or the fruit-based food product(s) can also be processed so as to be reduced to a concentrated fruit base product, and, if desired, can be frozen, packaged, jarred, canned, or bottled, at or during step 205, using any appropriate and/or suitable processing, reducing, concentrating, packaging, jarring, canning, or bottling, technique(s) and/or method(s).

In another preferred embodiment, the fruit base(s) can also be packaged, jarred, canned, or bottled, at or during step 203, or the fruit-based food product(s) can also be packaged, jarred, canned, or bottled, at or during step 205, using any appropriate and/or suitable packaging, jarring, canning, or bottling, technique(s) and/or method(s).

The reduced calorie vegetable-based or fruit-based food products and/or a reduced calorie vegetable-based or fruit-based food product ingredients of the present invention can be utilized in any desired way in order to make or prepare any desired food products, including, but not limited to, soups, broths, thickened broths, bisques, sauces, gravies, thickeners, chowders, stews, pot pies, pot pie fillings, quiches, custards, fillings, food fillings of any type or kind, pasta fillings, meat fillings, vegetable fillings, vegetable spreads, fruit spreads, stuffings, crepes, crepe fillings, desserts, dessert fillings, pie fillings, icings, cake fillings, jellies, jams, preserves, marmalades, syrups, syrups, breads, bread fillings, drinks, beverages, shakes, smoothies, and/or frozen desserts, and/or any other foods, food products, food ingredients, or food product ingredients.

In the manner described herein, the process and/or method of the present invention can be easily used in order to make or prepare a wide variety of reduced calorie vegetable-based food products or fruit-based food products and/or a reduced calorie vegetable-based, or fruit-based, food product ingredients, as well as wide variety of food dishes or food products which can be made or prepared with, from, or using, same.

In another preferred embodiment, as well as in any and/or all of the embodiments described herein, the reduced calorie vegetable-based or fruit-based food products and/or a reduced calorie vegetable-based or fruit-based food product ingredients of the present invention can have a smooth and/or thick texture and/or can also have a uniformly smooth consistency and/or texture.

In another preferred embodiment, as well as in any and/or all of the embodiments described herein, the reduced calorie vegetable-based or fruit-based food products and/or a reduced calorie vegetable-based or fruit-based food product ingredients of the present invention can be made or prepared commercially and/or in commercial manufacturing facilities and/or can be prepared by any individual.

In another preferred embodiment, as well as in any and/or all of the embodiments described herein, the reduced calorie vegetable-based or fruit-based food products and/or a reduced calorie vegetable-based or fruit-based food product ingredients of the present invention can be made or prepared without heavy creams, butters, oils, fats, sugars, or starches, and/or can be made or prepared to be gluten-free or lactose-free, in order to satisfy any dietary needs of any individual.

In another preferred embodiment, as well as any and/or all of the embodiments described herein, any “beamed” vegetable or fruit can be utilized as a low fat substitute for a pie crust, a quiche crust, a cooking bed or a baking bed, or can be used as a food or dish dressing or can be used for a food presentation purposes. In such an embodiment, any food processing step after “beaming” can be dispensed with, and the “beamed” vegetable or fruit can be removed from the cooking liquid and can be cut or sliced in any appropriate manner so as to be utilized as a low-fat vegetable or fruit substitute for a pie crust, a quiche crust, a cooking bed or a baking bed, or can be used as a food or dish dressing or can be used for a food presentation purposes. For example, a “beamed” squash can be sliced and used as a substitute for a quiche. As and for another example, a “beamed” fruit such as pears or apples can be sliced and used as a substitute for a fruit pie crust. It is important to note that, although specific examples have been given herein, there is simply no limit as the many ways in which the reduced calorie vegetable-based or fruit-based food products and/or the reduced calorie vegetable-based or fruit-based food product ingredients of the present invention can be used as a low fat substitute for ingredients or items used in making of preparing food products.

In another preferred embodiment, the process and/or method of the present invention can be utilized, for example, to make or prepare a vegetable base or a fruit base, and/or a vegetable-based food product or a fruit-based food product, which can be prepared by boiling one or more white vegetables or one or more fruits, in and using a cooking liquid which, depending upon the food product to be prepared, can be, or can include, water, broth, juice, flavored water, or any combination of same. The boiling process can be performed or carried out in any suitable cooking pot, vessel, or container.

The boiling operation serves to cook the white vegetable(s) or the fruit(s) a desired amount with as much of the nutrients as possible from the boiling process or operation being retained in either the white vegetable(s) or the fruit(s) and/or in the cooking liquid. Once the boiling process has been completed, the cooked white vegetable(s) or the fruit(s) and, either all or a portion of the cooking liquid in or with which they were boiled, can be food processed, or blended together, into and so as to form a respective smooth and/or creamy vegetable base or fruit base. In a preferred embodiment of the present invention, the resulting vegetable base or fruit base can be utilized, depending upon the food product to be made or prepared, as, or as an ingredient to or for, a soup, a broth, a thickened broth, a bisque, a sauce, a gravy, a thickener, a chowder, a stew, a pot pie, a pot pie filling, a quiche, a custard, a filling, a food filling of any type or kind, a pasta filling, a meat filling, a vegetable filling, a vegetable spread, a stuffing, a crepe, a crepe filling, a dessert, a dessert filling, a pie filling, a cake filling, an icing, jellies, jams, preserves, marmalades, syrups, a bread, a bread filling, a drink, a beverage, a shake, a smoothie, or a frozen dessert, or any other food, food product, food ingredient, or food product ingredient.

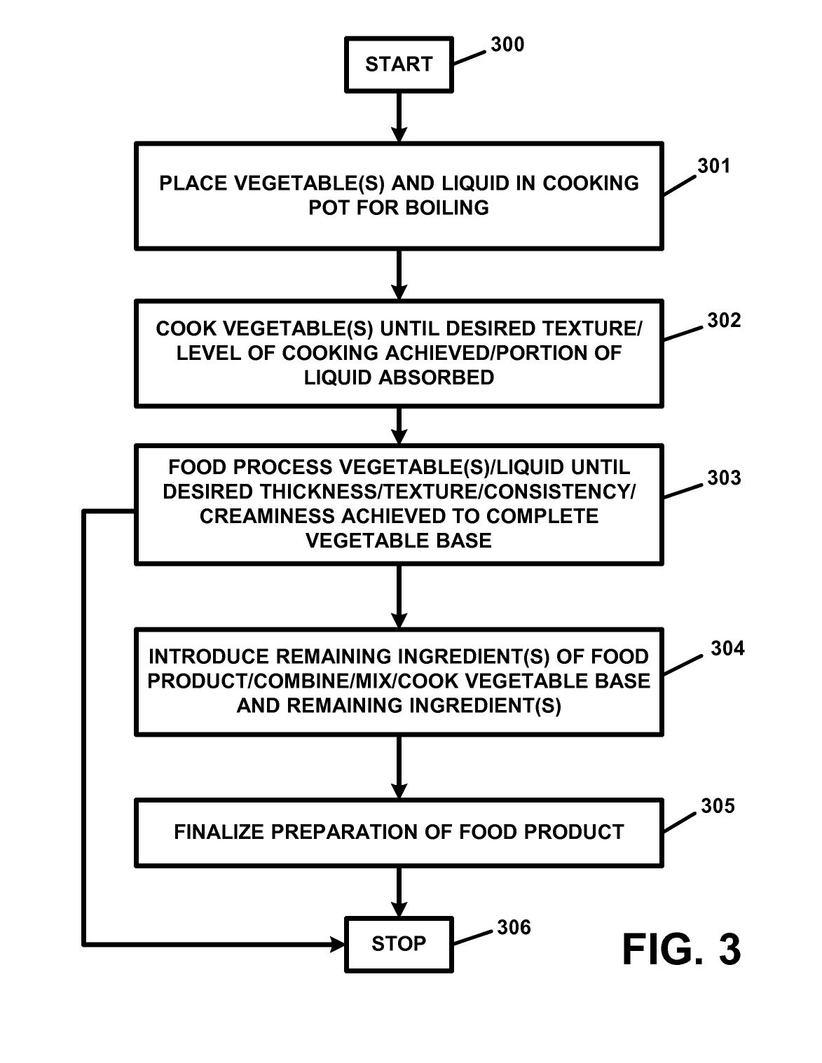

FIG. 3 illustrates a preferred embodiment method for making or preparing a reduced calorie vegetable-based product, and/or a reduced calorie vegetable-based food product ingredient, of the present invention, in flow diagram form. It is important to note that, although the preferred embodiment method of FIG. 3 is described and illustrated as being utilized to prepare a vegetable base or a vegetable-based food product, the method of the preferred embodiment of FIG. 3 can also be utilized in a same, a similar, and/or an analogous, manner in order to prepare a fruit base of a fruit-based food product.

With reference to FIG. 3, the process or method of the present invention commences at step 300. At step 301, a white vegetable, such as cauliflower, and/or any other white vegetable, or any other type or kind of vegetable for that matter, if desired, can be used for making the vegetable base. At step 301, the white vegetable can be placed in the cooking pot along with any other white vegetable, if used, or any other type or kind of vegetable, if used. The cooking liquid can then be added to the pot in any desired amount for boiling the white vegetable. In a preferred embodiment, the cooking liquid can be water, broth, juice, or any other flavored liquid, or any combination of same, in any desired mixture. In a preferred embodiment, the vegetable(s) can be placed on the bottom of the cooking pot and/or can be placed in a colander or steaming utensil within the cooking pot.

At step 301, if desired, any salt, pepper, or any other condiment or spice or spices, can also be added to the cooking pot. Thereafter, the cooking pot can be covered, if desired, so as to contain and/or retain all steam during cooking. The cooking pot can also be uncovered during the cooking process if desired.

At step 302, the cooking of the contents of the cooking pot can commence and the boiling of the white vegetable can be performed until the desired texture and/or amount of cooking is achieved. Once the boiling of the white vegetable is completed to the desired degree of cooking, the cooking process can cease.

At step 303, the cooking pot cover, if utilized, can be removed and the white vegetable and cooking liquid can be food processed or blended together either in the cooking pot or in a separate food processor or blender. In a preferred embodiment, the white vegetable can be food processed along with all, or with any portion of the cooking liquid, so as to obtain a vegetable base having the desired base texture. Since vital nutrients from the white vegetable can be retained in the cooking liquid, in a preferred embodiment, all of the cooking liquid can be used. In another embodiment, if a thicker texture is desired of the vegetable base, then some cooking liquid can be removed. In another preferred embodiment, any other ingredients can be added to the white vegetable and cooking liquid combination either before, during, or after, the food processing or blending step. If the vegetable base obtained from the food processing step is all that is required at the time, then the process and method of the present invention can be completed at the end of step 303 and the vegetable base can be used, consumed, or stored, as desired, and the process and/or method of the present invention will be completed at step 306.

At step 304, the remaining ingredients of the vegetable-based food product to be made with the vegetable base, which, in a preferred embodiment, were prepared separately from the vegetable base, can then be added to the vegetable base, and the vegetable base and the added remaining ingredients of the vegetable-based food product can be mixed together and/or can be cooked together, for a desired amount of time, to complete the vegetable-based food product. At step 304, any additional food processing or blending operation can also be performed, if desired. Any cooking or food processing performed at step 304 can be performed in the cooking pot, a food processor, or any other pot or container. At step 304, the contents of the cooking pot can also be further reduced so as to thicken same, if desired. Thereafter, at step 305, the preparation of the vegetable-based food product can be completed and the process and/or method of the present invention will be completed at step 306.

In another preferred embodiment, any appropriate and/or suitable preservative(s), chemical preservative(s), or additive(s), can be added to the vegetable base(s) at or during step 303, or can be added to the vegetable-based food product(s) at or during step 304 or at or during 305, so as to preserve same and/or to facilitate storing or packaging same for later consumption or use.

In another preferred embodiment, the vegetable base(s) can also be processed so as to be dehydrated or otherwise converted into a powdered form and, if desired, packaged, at or during step 303, or the vegetable-based food product(s) can also be processed so as to be dehydrated or otherwise converted into a powdered form and, if desired, can also be packaged, at or during step 305, using any appropriate and/or suitable processing, dehydrating, or other drying or conversion, or packaging, technique(s) and/or method(s).

In another preferred embodiment, the vegetable base(s) can also be processed so as to be frozen and, if desired, packaged at or during step 303, or the vegetable-based food product(s) can also be frozen and, if desired, packaged, at or during step 305, using any appropriate and/or suitable processing, freezing, or packaging, technique(s) and/or method(s).

In another preferred embodiment, the vegetable base(s) can also be processed so as to be freeze-dried and, if desired, packaged at or during step 303, or the vegetable-based food product(s) can also be processed so as to be freeze-dried and, if desired, packaged, at or during step 305, using any appropriate and/or suitable processing, freezing-drying, or packaging, technique(s) and/or method(s).

In another preferred embodiment, the vegetable base(s) can also be processed so as to be reduced to a concentrated vegetable base product, and, if desired, can be frozen, packaged, jarred, canned, or bottled, at or during step 303, or the vegetable-based food product(s) can also be processed so as to be reduced to a concentrated vegetable base product, and, if desired, can be frozen, packaged, jarred, canned, or bottled, at or during step 305, using any appropriate and/or suitable processing, reducing, concentrating, packaging, jarring, canning, or bottling, technique(s) and/or method(s).

In another preferred embodiment, the vegetable base(s) can also be packaged, jarred, canned, or bottled, at or during step 303, or the vegetable-based food product(s) can also be packaged, jarred, canned, or bottled, at or during step 305, using any appropriate and/or suitable packaging, jarring, canning, or bottling, technique(s) and/or method(s).

In another preferred embodiment, the method of the preferred embodiment of FIG. 3 can be utilized in a same, a similar, and/or an analogous, manner to make or prepare any fruit base or any fruit-based food product, or any fruit-based ingredient for a food product. In a preferred embodiment, the process and/or method of the preferred embodiment of FIG. 3 of the present invention can be utilized, in a same, a similar, and/or an analogous, manner, in order to make or prepare a fruit base which can be prepared by boiling one or more fruits in and using a cooking liquid which, depending upon the food product to be prepared, can be, or can include, water, broth, juice, flavored water, or any combination of same.

Once the boiling process has been completed, the cooked fruit(s) and, either all or a portion of the cooking liquid in or with which they were boiled, can be food processed, or blended together, into and so as to form a smooth and/or creamy fruit base. In a preferred embodiment of the present invention, the resulting fruit base can be utilized, depending upon the food product to be made or prepared, as, or an ingredient of or for, a thickener, a custard, a filling, a food filling of any type or kind, a pasta filling, a meat filling, a vegetable filling, a stuffing, a crepe, a crepe filling, a dessert, a dessert filling, a pie filling, a cake filling, an icing, a fruit spread, a jelly, a jam, preserves, a marmalade, syrup, a bread, a bread filling, a drink, a beverage, a shake, a smoothie, or a frozen dessert, or any other food, food product, food ingredient, or food product ingredient.

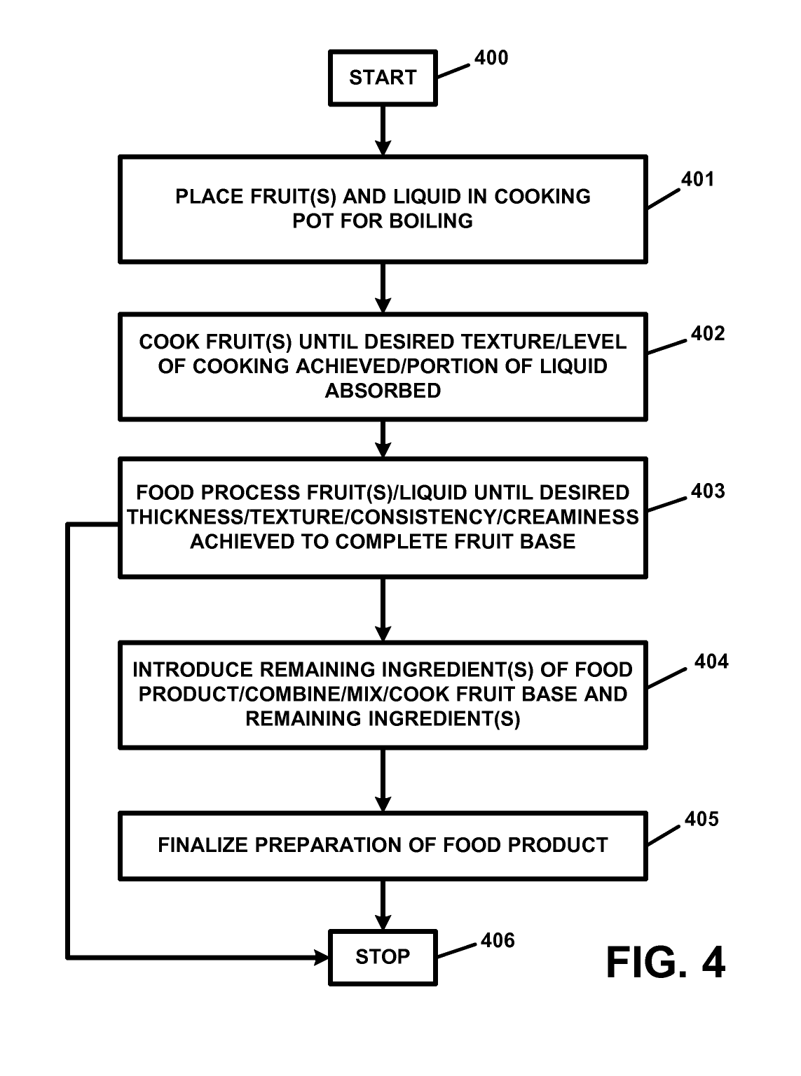

FIG. 4 illustrates a preferred embodiment method for making or preparing a reduced calorie fruit-based food product, and/or a reduced calorie fruit-based food product ingredient, of the present invention, in flow diagram form. With reference to FIG. 4 the process or method of the present invention commences at step 400. At step 401, a fruit or fruits, such as blueberries or strawberries, or any combination of fruits, if desired, can be placed in the cooking pot and/or in a colander or steaming utensil within the cooking pot. In a preferred embodiment, the cooking liquid can be water, juice, or any other flavored liquid, or any combination of same, in any desired mixture. In a preferred embodiment, the fruit(s) can be placed on the bottom of the cooking pot and/or can be placed in a colander or steaming utensil within the cooking pot.

At step 401, if desired, any other ingredients can also be added to the cooking pot. Thereafter, the cooking pot can be covered, if desired, so as to contain and/or retain all steam during cooking. The cooking pot can also be uncovered during the cooking process if desired.

At step 402, the cooking of the contents of the cooking pot can commence and the boiling of the fruit(s) can be performed until the desired texture and/or amount of cooking is achieved. Once the boiling of the fruit(s) is completed to the desired degree of cooking, the cooking process can cease.

At step 403, the cooking pot cover, if used, can be removed and the fruit(s) and cooking liquid can be food processed or blended together either in the cooking pot or in a separate food processor or blender. In a preferred embodiment, the fruit(s) can be food processed along with all, or with any portion of the cooking liquid, so as to obtain a fruit base having the desired base texture. Since vital nutrients from the blueberries can be retained in the cooking liquid, in a preferred embodiment, all of the cooking liquid can be used. In another embodiment, if a thicker texture is desired of the fruit base, then some cooking liquid can be removed. In another preferred embodiment, any other ingredients can be added to the fruit(s) and cooking liquid combination either before, during, or after, the food processing or blending step. If the fruit base obtained from the food processing step is all that is required at the time, then the process and method of the present invention can be completed at the end of step 403 and the fruit base can be used, consumed, or stored, as desired, and the process and/or method of the present invention will be completed at step 406.

At step 404, any additional ingredients can be added to the fruit base, such as, for example, whole and/or cut fresh fruit(s), or any ingredient(s), and the fruit base and the added ingredients can be mixed together and/or can be cooked together, if desired, for any desired amount of time in order to complete the fruit-base food product. At step 404, any additional food processing or blending operation can also be performed, if desired. Any cooking or food processing performed at step 404 can be performed in the cooking pot, a food processor, or any other pot or container. At step 404, the contents of the cooking pot can also be further reduced so as to thicken same, if desired. Thereafter, at step 405, the completed fruit-based food product can be used as a filling or stuffing to make or prepare crepes, filled or stuffed pasta, raviolis, or pierogies, or any other fruit-filled food products, and the process and/or method of the present invention will be completed at step 406.

In another preferred embodiment, any appropriate and/or suitable preservative(s), chemical preservative(s), or additive(s), can be added to the fruit base(s) at or during step 403, or can be added to the fruit-based food product(s) at or during step 404 or at or during 405, so as to preserve same and/or to facilitate storing or packaging same for later consumption or use.

In another preferred embodiment, the fruit base(s) can also be processed so as to be dehydrated or otherwise converted into a powdered form and, if desired, packaged, at or during step 403, or the fruit-based food product(s) can also be processed so as to be dehydrated or otherwise converted into a powdered form and, if desired, can also be packaged, at or during step 405, using any appropriate and/or suitable processing, dehydrating, or other drying or conversion, or packaging, technique(s) and/or method(s).

In another preferred embodiment, the fruit base(s) can also be processed so as to be frozen and, if desired, packaged at or during step 403, or the fruit-based food product(s) can also be frozen and, if desired, packaged, at or during step 405, using any appropriate and/or suitable processing, freezing, or packaging, technique(s) and/or method(s).

In another preferred embodiment, the fruit base(s) can also be processed so as to be freeze-dried and, if desired, packaged at or during step 403, or the fruit-based food product(s) can also be processed so as to be freeze-dried and, if desired, packaged, at or during step 405, using any appropriate and/or suitable processing, freezing-drying, or packaging, technique(s) and/or method(s).

In another preferred embodiment, the fruit base(s) can also be processed so as to be reduced to a concentrated vegetable base product, and, if desired, can be frozen, packaged, jarred, canned, or bottled, at or during step 403, or the fruit-based food product(s) can also be processed so as to be reduced to a concentrated fruit base product, and, if desired, can be frozen, packaged, jarred, canned, or bottled, at or during step 405, using any appropriate and/or suitable processing, reducing, concentrating, packaging, jarring, canning, or bottling, technique(s) and/or method(s).

In another preferred embodiment, the fruit base(s) can also be packaged, jarred, canned, or bottled, at or during step 403, or the fruit-based food product(s) can also be packaged, jarred, canned, or bottled, at or during step 405, using any appropriate and/or suitable packaging, jarring, canning, or bottling, technique(s) and/or method(s).

In another preferred embodiment, the process and/or method of the present invention can be utilized, for example, to make or prepare a vegetable base or a fruit base, and/or a vegetable-based food product or a fruit-based food product, which can be prepared by steaming one or more white vegetables or one or more fruits, in, with, and/or using, a cooking liquid which, depending upon the food product to be prepared, can be, or can include, water, broth, juice, flavored water, or any combination of same. The steaming process can be performed or carried out in any suitable cooking pot, vessel, or container.

The steaming operation serves to cook the white vegetable(s) or the fruit(s) a desired amount with as much of the nutrients as possible from the steaming process or operation being retained in either the white vegetable(s) or the fruit(s) and/or in the cooking liquid. Once the steaming process has been completed, the cooked white vegetable(s) or the fruit(s) and, either all or a portion of the cooking liquid in or with which they were steaming, can be food processed, or blended together, into and so as to form a respective smooth and/or creamy vegetable base or fruit base. In a preferred embodiment of the present invention, the resulting vegetable base or fruit base can be utilized, depending upon the food product to be made or prepared, as, or an ingredient to or for, a soup, a broth, a thickened broth, a bisque, a sauce, a gravy, a thickener, a chowder, a stew, a pot pie, a pot pie filling, a quiche, a custard, a filling, a food filling of any type or kind, a pasta filling, a meat filling, a vegetable filling, a vegetable spread, a stuffing, a crepe, a crepe filling, a dessert, a dessert filling, a pie filling, a cake filling, an icing, jellies, jams, preserves, marmalades, syrups, a bread, a bread filling, a drink, a beverage, a shake, a smoothie, or a frozen dessert, or any other food, food product, food ingredient, or food product ingredient.

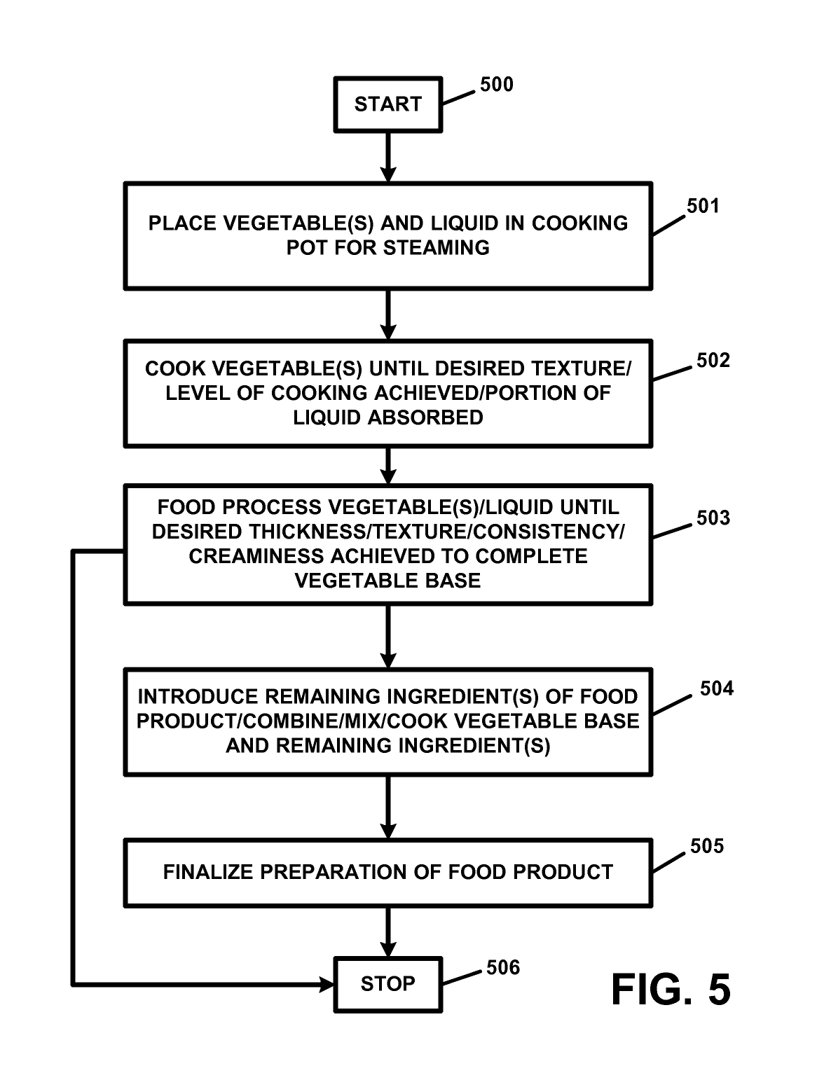

FIG. 5 illustrates a preferred embodiment method for making or preparing a reduced calorie vegetable-based product, and/or a reduced calorie vegetable-based food product ingredient, of the present invention, in flow diagram form. It is important to note that, although the preferred embodiment method of FIG. 5 is described and illustrated as being utilized to prepare a vegetable base or a vegetable-based food product, the method of the preferred embodiment of FIG. 5 can also be utilized in a same, a similar, and/or an analogous, manner in order to prepare a fruit base of a fruit-based food product.

With reference to FIG. 5, the process or method of the present invention commences at step 500. At step 501, a white vegetable, such as cauliflower, and/or any other white vegetable, or any other type or kind of vegetable for that matter, if desired, can be used for making the vegetable base. At step 501, the white vegetable can be placed in the cooking pot along with any other white vegetable, if used, or any other type or kind of vegetable, if used. The cooking liquid can then be added to the pot in any desired amount for steaming the white vegetable. In a preferred embodiment, the cooking liquid can be water, broth, juice, or any other flavored liquid, or any combination of same, in any desired mixture. In a preferred embodiment, the vegetable(s) can be placed on the bottom of the cooking pot and/or can be placed in a colander or steaming utensil within the cooking pot.

At step 501, if desired, any salt, pepper, or any other condiment or spice or spices, can also be added to the cooking pot. Thereafter, the cooking pot can be covered, if desired, so as to contain and/or retain all steam during cooking. The cooking pot can also be uncovered during the cooking process if desired.

At step 502, the cooking of the contents of the cooking pot can commence and the steaming of the white vegetable can be performed until the desired texture and/or amount of cooking is achieved. Once the steaming of the white vegetable is completed to the desired degree of cooking, the cooking process can cease.

At step 503, the cooking pot cover can be removed and the white vegetable and cooking liquid can be food processed or blended together either in the cooking pot or in a separate food processor or blender. In a preferred embodiment, the white vegetable can be food processed along with all, or with any portion of the cooking liquid, so as to obtain a vegetable base having the desired base texture. Since vital nutrients from the white vegetable can be retained in the cooking liquid, in a preferred embodiment, all of the cooking liquid can be used. In another embodiment, if a thicker texture is desired of the vegetable base, then some cooking liquid can be removed. In another preferred embodiment, any other ingredients can be added to the white vegetable and cooking liquid combination either before, during, or after, the food processing or blending step. If the vegetable base obtained from the food processing step is all that is required at the time, then the process and method of the present invention can be completed at the end of step 503 and the vegetable base can be used, consumed, or stored, as desired, and the process and/or method of the present invention will be completed at step 306.

At step 504, the remaining ingredients of the vegetable-based food product to be made with the vegetable base, which, in a preferred embodiment, were prepared separately from the vegetable base, can then be added to the vegetable base, and the vegetable base and the added remaining ingredients of the vegetable-based food product can be mixed together and/or can be cooked together, for a desired amount of time, to complete the vegetable-based food product. At step 504, any additional food processing or blending operation can also be performed, if desired. Any cooking or food processing performed at step 504 can be performed in the cooking pot, a food processor, or any other pot or container. At step 504, the contents of the cooking pot can also be further reduced so as to thicken same, if desired. Thereafter, at step 505, the preparation of the vegetable-based food product can be completed and the process and/or method of the present invention will be completed at step 506.

In another preferred embodiment, any appropriate and/or suitable preservative(s), chemical preservative(s), or additive(s), can be added to the vegetable base(s) at or during step 503, or can be added to the vegetable-based food product(s) at or during step 504 or at or during 505, so as to preserve same and/or to facilitate storing or packaging same for later consumption or use.

In another preferred embodiment, the vegetable base(s) can also be processed so as to be dehydrated or otherwise converted into a powdered form and, if desired, packaged, at or during step 503, or the vegetable-based food product(s) can also be processed so as to be dehydrated or otherwise converted into a powdered form and, if desired, can also be packaged, at or during step 505, using any appropriate and/or suitable processing, dehydrating, or other drying or conversion, or packaging, technique(s) and/or method(s).

In another preferred embodiment, the vegetable base(s) can also be processed so as to be frozen and, if desired, packaged at or during step 503, or the vegetable-based food product(s) can also be frozen and, if desired, packaged, at or during step 505, using any appropriate and/or suitable processing, freezing, or packaging, technique(s) and/or method(s).

In another preferred embodiment, the vegetable base(s) can also be processed so as to be freeze-dried and, if desired, packaged at or during step 503, or the vegetable-based food product(s) can also be processed so as to be freeze-dried and, if desired, packaged, at or during step 505, using any appropriate and/or suitable processing, freezing-drying, or packaging, technique(s) and/or method(s).

In another preferred embodiment, the vegetable base(s) can also be processed so as to be reduced to a concentrated vegetable base product, and, if desired, can be frozen, packaged, jarred, canned, or bottled, at or during step 503, or the vegetable-based food product(s) can also be processed so as to be reduced to a concentrated vegetable base product, and, if desired, can be frozen, packaged, jarred, canned, or bottled, at or during step 505, using any appropriate and/or suitable processing, reducing, concentrating, packaging, jarring, canning, or bottling, technique(s) and/or method(s).

In another preferred embodiment, the vegetable base(s) can also be packaged, jarred, canned, or bottled, at or during step 503, or the vegetable-based food product(s) can also be packaged, jarred, canned, or bottled, at or during step 505, using any appropriate and/or suitable packaging, jarring, canning, or bottling, technique(s) and/or method(s).

In another preferred embodiment, the method of the preferred embodiment of FIG. 5 can be utilized in a same, a similar, and/or an analogous, manner to make or prepare any fruit base or any fruit-based food product, or any fruit-based ingredient for a food product. In a preferred embodiment, the process and/or method of the preferred embodiment of FIG. 5 of the present invention can be utilized, in a same, a similar, and/or an analogous, manner, in order to make or prepare a fruit base which can be prepared by steaming one or more fruits in and using a cooking liquid which, depending upon the food product to be prepared, can be, or can include, water, broth, juice, flavored water, or any combination of same.

Once the steaming process has been completed, the cooked fruit(s) and, either all or a portion of the cooking liquid in or with which they were boiled, can be food processed, or blended together, into and so as to form a smooth and/or creamy fruit base. In a preferred embodiment of the present invention, the resulting fruit base can be utilized, depending upon the food product to be made or prepared, as, or an ingredient of or for, a thickener, a custard, a filling, a food filling of any type or kind, a pasta filling, a meat filling, a vegetable filling, a stuffing, a crepe, a crepe filling, a dessert, a dessert filling, a pie filling, a cake filling, an icing, a fruit spread, a jelly, a jam, preserves, a marmalade, syrup, a bread, a bread filling, a drink, a beverage, a shake, a smoothie, or a frozen dessert, or any other food, food product, food ingredient, or food product ingredient.

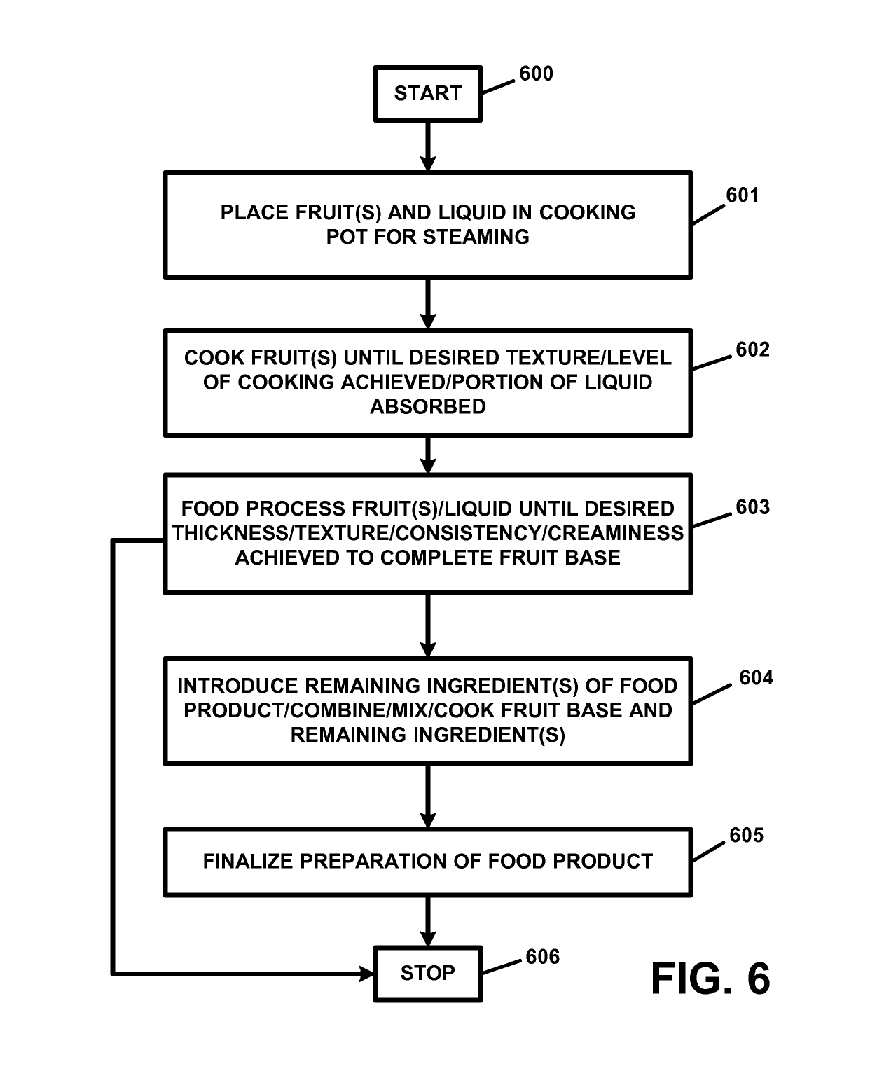

FIG. 6 illustrates a preferred embodiment method for making or preparing a reduced calorie fruit-based food product, and/or a reduced calorie fruit-based food product ingredient, of the present invention, in flow diagram form. With reference to FIG. 6 the process or method of the present invention commences at step 600. At step 601, a fruit or fruits, such as blueberries or strawberries, or any combination of fruits, if desired, can be placed in the cooking pot and/or in a colander or steaming utensil within the cooking pot. In a preferred embodiment, the cooking liquid can be water, juice, or any other flavored liquid, or any combination of same, in any desired mixture. In a preferred embodiment, the fruit(s) can be placed on the bottom of the cooking pot and/or can be placed in a colander or steaming utensil within the cooking pot.

At step 601, if desired, any other ingredients can also be added to the cooking pot. Thereafter, the cooking pot can be covered.

At step 602, the cooking of the contents of the cooking pot can commence and the steaming of the fruit(s) can be performed until the desired texture and/or amount of cooking is achieved. Once the steaming of the fruit(s) is completed to the desired degree of cooking, the cooking process can cease.

At step 603, the cooking pot cover can be removed and the fruit(s) and cooking liquid can be food processed or blended together either in the cooking pot or in a separate food processor or blender. In a preferred embodiment, the fruit(s) can be food processed along with all, or with any portion of the cooking liquid, so as to obtain a fruit base having the desired base texture. Since vital nutrients from the blueberries can be retained in the cooking liquid, in a preferred embodiment, all of the cooking liquid can be used. In another embodiment, if a thicker texture is desired of the fruit base, then some cooking liquid can be removed. In another preferred embodiment, any other ingredients can be added to the fruit(s) and cooking liquid combination either before, during, or after, the food processing or blending step. If the fruit base obtained from the food processing step is all that is required at the time, then the process and method of the present invention can be completed at the end of step 603 and the fruit base can be used, consumed, or stored, as desired, and the process and/or method of the present invention will be completed at step 606.

At step 604, any additional ingredients can be added to the fruit base, such as, for example, whole and/or cut fresh fruit(s), or any ingredient(s), and the fruit base and the added ingredients can be mixed together and/or can be cooked together, if desired, for any desired amount of time in order to complete the fruit-base food product. At step 604, any additional food processing or blending operation can also be performed, if desired. Any cooking or food processing performed at step 604 can be performed in the cooking pot, a food processor, or any other pot or container. At step 604, the contents of the cooking pot can also be further reduced so as to thicken same, if desired. Thereafter, at step 605, the completed fruit-based food product can be used as a filling or stuffing to make or prepare crepes, filled or stuffed pasta, raviolis, or pierogies, or any other fruit-filled food products, and the process and/or method of the present invention will be completed at step 606.

In another preferred embodiment, any appropriate and/or suitable preservative(s), chemical preservative(s), or additive(s), can be added to the fruit base(s) at or during step 603, or can be added to the fruit-based food product(s) at or during step 604 or at or during 605, so as to preserve same and/or to facilitate storing or packaging same for later consumption or use.

In another preferred embodiment, the fruit base(s) can also be processed so as to be dehydrated or otherwise converted into a powdered form and, if desired, packaged, at or during step 603, or the fruit-based food product(s) can also be processed so as to be dehydrated or otherwise converted into a powdered form and, if desired, can also be packaged, at or during step 605, using any appropriate and/or suitable processing, dehydrating, or other drying or conversion, or packaging, technique(s) and/or method(s).

In another preferred embodiment, the fruit base(s) can also be processed so as to be frozen and, if desired, packaged at or during step 603, or the fruit-based food product(s) can also be frozen and, if desired, packaged, at or during step 605, using any appropriate and/or suitable processing, freezing, or packaging, technique(s) and/or method(s).

In another preferred embodiment, the fruit base(s) can also be processed so as to be freeze-dried and, if desired, packaged at or during step 603, or the fruit-based food product(s) can also be processed so as to be freeze-dried and, if desired, packaged, at or during step 605, using any appropriate and/or suitable processing, freezing-drying, or packaging, technique(s) and/or method(s).

In another preferred embodiment, the fruit base(s) can also be processed so as to be reduced to a concentrated vegetable base product, and, if desired, can be frozen, packaged, jarred, canned, or bottled, at or during step 603, or the fruit-based food product(s) can also be processed so as to be reduced to a concentrated fruit base product, and, if desired, can be frozen, packaged, jarred, canned, or bottled, at or during step 605, using any appropriate and/or suitable processing, reducing, concentrating, packaging, jarring, canning, or bottling, technique(s) and/or method(s).

In another preferred embodiment, the fruit base(s) can also be packaged, jarred, canned, or bottled, at or during step 603, or the fruit-based food product(s) can also be packaged, jarred, canned, or bottled, at or during step 605, using any appropriate and/or suitable packaging, jarring, canning, or bottling, technique(s) and/or method(s).

In another preferred embodiment, as well as any and/or all of the embodiments described herein, vegetables such as onions, cabbage, potatoes, or other like vegetables, can also be utilized in a cooking or baking process. For example, an onion or onions can be sliced and used as a vegetable baking bed which can serve a bad upon which a food product can be place during cooking or baking. For example, a meatloaf make with any combination of or type of meats can be placed on a bed of onions slices or onion pieces in order to provide a non-fat or low fat cooking or backing surface.

In a preferred embodiment, any of the vegetable bases, vegetable-based food products, fruit bases, or fruit-based food products, described herein can be prepared or produced in any quantities, can be prepared or produced for individual consumption, for family consumption, for mass consumption, and/or can be prepared or produced for commercial sale. In a preferred embodiment, any of the vegetable bases, vegetable-based food products, fruit bases, or fruit-based food products, described herein also can be canned, jarred, bottled, dehydrated, dehydrated into a powdered form, frozen, freeze-dried, or prepared as a frozen concentrate, and/or can be packaged, jarred, canned, or bottled, for personal use or for commercial distribution, use, and/or sale.

In another preferred embodiment, any of the vegetable bases or fruit bases of the present invention, or any food products or ingredients of or for food products, which can be made or prepared with or from same, can be further processed, in any appropriate and/or suitable manner, so as to be dried or dehydrated so as to convert same to a powdered form for later rehydration and use, or can be frozen for later use, or can be freeze-dried for later user. In this regard, the process and/or method of the present invention can also include a respective dehydration process, a freezing process, or a freeze-drying process and/or the vegetable bases or fruit bases of the present invention, or any food products or ingredients of or for food products, which can be made or prepared with or from same, can be dehydrated or powered vegetable bases or fruit bases of the present invention, or any food products or ingredients of or for food products, frozen vegetable bases or fruit bases of the present invention, or any food products or ingredients of or for food products, or freeze-dried vegetable bases or fruit bases of the present invention, or any food products or ingredients of or for food products.

In any and/or all of the embodiments described herein any type, kind, or variety of vegetables including, but not limited to, white vegetables, green vegetables, root vegetables, or any other vegetables or vegetable-like products, items, or entities, can be used to make or to prepare any vegetable base described herein or otherwise or any reduced calorie food product or a reduced calorie food product ingredient of the present invention.

In any and/or all of the embodiments described herein any type, kind, or variety of fruits including, but not limited to, white fruits, citrus fruits, berries, strawberries, blueberries, blackberries, raspberries, bananas, cherries, oranges, grapefruits, peaches, pears, plums, prunes, currants, or any other fruit or fruit-like products, items, or entities, can be used to make or to prepare a fruit base described herein or otherwise or any reduced calorie food product or a reduced calorie food product ingredient of the present invention.

In any and/or all of the embodiments described herein, any of the herein-described vegetable-based or fruit-based food products and/or reduced calorie vegetable-based or fruit-based food product ingredients, can also prepared, or made, with or including any suitable food, nutritional, or dietary, supplement, such as, but not limited to, a liquid vitamin or a liquid vitamin mixture, a liquid food supplement, a liquid nutritional supplement, a liquid dietary supplement, a liquid energy product, or any other liquid supplement or supplements.

In any and/or all of the embodiments described herein, any of the herein-described vegetable-based or fruit-based food products and/or reduced calorie vegetable-based or fruit-based food product ingredients, can also prepared, or made, with or including any solid or powdered form of a vitamin or a vitamin mixture, a solid or powdered form of a food supplement, nutritional supplement, or dietary supplement, a solid or powdered energy product, or any other solid or powdered food, nutritional, or dietary, supplement or supplements.

The vegetable bases, the vegetable-based food products, or the fruit bases or the fruit-based food products, of the present invention, and/or prepared by and using the processes and methods of the present invention can be used to prepare and/or make any number, kinds, or types, of a wide variety of food products or ingredients for food products. As and for an exemplary and non-exhaustive list, the vegetable bases, the vegetable-based food products, or the fruit bases, or the fruit-based food products, of the present invention can be prepared as, or can be an ingredient for, mashed potatoes, mashed cauliflower, mashed vegetables of any type or kind or of any combination, macaroni and cheese, hashed browns, au gratin potatoes, crab cakes, fish cakes, fish sticks, Shepherd's pie, dips of any type of kind, hummus, and/or any other food product or food product ingredient which can be prepared or made by using the process and method of the present invention, and/or any type of kind of soups, broths, thickened broths, bisques, sauces, gravies, thickeners, chowders, stews, pot pies, pot pie fillings, quiches, custards, fillings, food fillings of any type or kind, pasta fillings, meat fillings, vegetable fillings, vegetable spreads, stuffings, crepes, crepe fillings, desserts, dessert fillings, pie fillings, cake fillings, icings, jellies, jams, preserves, marmalades, syrups, breads, bread fillings, drinks, beverages, shakes, smoothies, or frozen desserts, or any other foods, food products, food ingredients, or food product ingredients.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A reduced calorie food product or a reduced calorie food product ingredient made or prepared by a process, comprising:
boiling, steaming, or simultaneously boiling and steaming, a white vegetable or a fruit in, with, or using, a cooking liquid in or using a cooking pot or a cooking utensil;
food processing or blending the white vegetable or the fruit with at least a portion of the cooking liquid to form a vegetable base for the reduced calorie food product or for the reduced calorie food ingredient or to form a fruit base for the reduced calorie food product or for the reduced calorie food ingredient; and
combining, adding, mixing, food processing, blending, or using, the vegetable base or the fruit base with at least one additional ingredient of the reduced calorie food product or the reduced calorie food product ingredient to finalize a preparation of the reduced calorie food product or the reduced calorie food product ingredient.

2. The reduced calorie food product or a reduced calorie food product ingredient of claim 1, wherein the reduced calorie food product or the reduced calorie food product ingredient is or contains a soup, a broth, a thickened broth, a bisque, a sauce, a gravy, a thickener, a chowder, a stew, a pot pie, a pot pie filling, a quiche, a custard, a filling, a food filling, a pasta filling, a meat filling, a vegetable filling, a vegetable spread, a fruit spread, a stuffing, a crepe, a crepe filling, a dessert, a dessert filling, a pie filling, an icing, a cake filling, a jelly, a jam, a preserve, a marmalade, a syrup, a bread, a bread filling, a drink, a beverage, a shake, a smoothie, or a frozen desserts.

3. The reduced calorie food product or a reduced calorie food product ingredient of claim 1, wherein the white vegetable is cauliflower.

4. The reduced calorie food product or a reduced calorie food product ingredient of claim 1, wherein the white vegetable is garlic, an onion, shallots, or leeks.

5. The reduced calorie food product or a reduced calorie food product ingredient of claim 1, wherein the white vegetable is a cruciferous vegetable.

6. The reduced calorie food product or a reduced calorie food product ingredient of claim 1, wherein is a vegetable having a bland, a neutral, or a weak, taste or flavor.

7. The reduced calorie food product or a reduced calorie food product ingredient of claim 1, wherein the fruit is a white fruit.

8. The reduced calorie food product or a reduced calorie food product ingredient of claim 1, wherein the fruit is apple, pear, coconut, or banana.

9. The reduced calorie food product or a reduced calorie food product ingredient of claim 1, wherein the cooking liquid is water.

10. The reduced calorie food product or a reduced calorie food product ingredient of claim 1, wherein the cooking liquid is a juice or a broth.

11. The reduced calorie food product or a reduced calorie food product ingredient of claim 1, wherein the cooking liquid contains a mixture of water with a juice or contains a mixture of water with a broth.

12. The reduced calorie food product or a reduced calorie food product ingredient of claim 1 which is prepared by a process, further comprising:
dehydrating the reduced calorie food product or a reduced calorie food product ingredient into a powdered form.

13. The reduced calorie food product or a reduced calorie food product ingredient of claim 1 which is prepared by a process, further comprising:
freezing or freeze-drying the reduced calorie food product or the reduced calorie food product ingredient, or reducing the reduced calorie food product or the reduced calorie food product ingredient into a concentrated form.

14. A reduced calorie food product or a reduced calorie food product ingredient made or prepared by a process, comprising:
boiling, steaming, or simultaneously boiling and steaming, a white vegetable or a fruit in, with, or using, a cooking liquid in or using a cooking pot or a cooking utensil; and
food processing or blending the white vegetable or the fruit with at least a portion of the cooking liquid to form a vegetable base for the reduced calorie food product or for the reduced calorie food ingredient or to form a fruit base for the reduced calorie food product or for the reduced calorie food ingredient.

15. The reduced calorie food product or a reduced calorie food product ingredient of claim 14, wherein the vegetable base or the fruit base is, or is an ingredient for, a soup, a broth, a thickened broth, a bisque, a sauce, a gravy, a thickener, a chowder, a stew, a pot pie, a pot pie filling, a quiche, a custard, a filling, a food filling, a pasta filling, a meat filling, a vegetable filling, a vegetable spread, a fruit spread, a stuffing, a crepe, a crepe filling, a dessert, a dessert filling, a pie filling, an icing, a cake filling, a jelly, a jam, a preserve, a marmalade, a syrup, a bread, a bread filling, a drink, a beverage, a shake, a smoothie, or a frozen desserts.

16. The reduced calorie food product or a reduced calorie food product ingredient of claim 14, wherein the white vegetable is cauliflower, garlic, an onion, shallots, or leeks, or wherein the white vegetable is a cruciferous vegetable.

17. The reduced calorie food product or a reduced calorie food product ingredient of claim 14, wherein the fruit is a white fruit, apple, pear, coconut, or banana.

18. The reduced calorie food product or a reduced calorie food product ingredient of claim 14, wherein the fruit is blueberry, strawberry, or kiwi fruit.

19. The reduced calorie food product or a reduced calorie food product ingredient of claim 14, wherein the cooking liquid is water, a juice, or a broth, or wherein the cooking liquid is a mixture of water and a juice or a mixture of water and a broth.

20. The reduced calorie food product or a reduced calorie food product ingredient of claim 1 which is prepared by a process, further comprising:
dehydrating the vegetable base or the fruit base into a powdered form, or freezing or freeze-drying the vegetable base or the fruit base, or reducing the vegetable base or the fruit base into a concentrated form.
